(19) United States
(12) Patent Application Publication
(10) Pub. No.: US 2026/0196726 A1
(43) Pub. Date: Jul. 9, 2026

(54) ANTENNA MODULE AND ELECTRONIC DEVICE INCLUDING THE SAME

(71) Applicant: Samsung Electronics Co., Ltd., Suwon-si (KR)

(72) Inventors: Hyewon JO, Suwon-si (KR); Namjun CHO, Suwon-si (KR); Hyoseok NA, Suwon-si (KR)

(21) Appl. No.: 19/560,972

(22) Filed: Mar. 9, 2026

Related U.S. Application Data
(63) Continuation of application No. PCT/KR2025/019110, filed on Nov. 18, 2025.

(30) Foreign Application Priority Data
Nov. 18, 2024 (KR) 10-2024-0164081
Jan. 9, 2025 (KR) 10-2025-0003721

(51) Int. Cl. H01Q 5/20; H01Q 9/04; H01Q 21/06

(52) U.S. Cl. CPC H01Q 5/20; H01Q 9/0407; H01Q 21/065

(57) ABSTRACT

An electronic device includes: at least one processor, wireless communication circuitry coupled to the at least one processor, and an antenna module coupled to the wireless communication circuitry. The antenna module includes a circuit board on which a first radiator array for a first frequency band, a second radiator array for a second frequency band higher than the first frequency band, and a third radiator array for a third frequency band lower than the first frequency band are disposed. The first radiator array includes patch radiators having a first size, disposed on a first layer among a plurality of layers of the circuit board. The second radiator array includes patch radiators having a second size smaller than the first size, disposed on a second layer above the first layer with respect to a side of the circuit board among the plurality of layers of the circuit board.

### CROSS-REFERENCE TO RELATED APPLICATIONS

This application is a continuation application, claiming priority under 35 U.S.C. § 365(c), of an International application No. PCT/KR2025/019110, filed on Nov. 18, 2025, which is based on and claims the benefit of a Korean patent application number 10-2024-0164081, filed on Nov. 18, 2024, in the Ministry of Intellectual Property, and of a Korean patent application number 10-2025-0003721, filed on Jan. 9, 2025, in the Ministry of Intellectual Property, the disclosure of each of which is incorporated by reference herein in its entirety.

### BACKGROUND

### Field

The disclosure relates to an antenna module and an electronic device including the antenna module.

### Description of Related Art

An electronic device may include an antenna module for wireless communication with an external electronic device. The antenna module may include a plurality of antennas as array antennas for beamforming.

The above-described information may be provided as a related art for the purpose of helping understanding of the present disclosure. No determination or decision is made as to whether any of the above description may be applied as a prior art related to the present disclosure.

### SUMMARY

According to example embodiments of the present disclosure, an electronic device is provided. The electronic device may comprise: at least one processor, comprising processing circuitry, wireless communication circuitry coupled to at least one processor, and an antenna module coupled to the wireless communication circuitry. The antenna module may include: a circuit board on which a first radiator array for a first frequency band, a second radiator array for a second frequency band higher than the first frequency band, and a third radiator array for a third frequency band lower than the first frequency band are disposed. The first radiator array may include patch radiators having a first size, disposed on a first layer among a plurality of layers of the circuit board. The second radiator array may include patch radiators having a second size smaller than the first size, disposed on a second layer of the circuit board above the first layer with respect to a side of the circuit board among the plurality of layers of the circuit board. The third radiator array may include patch radiators having a third size larger than the first size, disposed on a third layer of the circuit board below the first layer with respect to the side of the circuit board among the plurality of layers of the circuit board. The patch radiators disposed on the second layer may be disposed to overlap the patch radiators disposed on the first layer, respectively. The patch radiators disposed on the third layer may include a patch radiator having a first patch portion partially overlapping with one of two adjacent patch radiators among the patch radiators disposed on the first layer and a second patch portion partially overlapping with another of the two adjacent patch radiators. A gap formed between the first patch portion and the second patch portion may be disposed on an area between the two adjacent patch radiators.

According to example embodiments of the present disclosure, an antenna module is provided. The antenna module may comprise: a circuit board on which a first radiator array for a first frequency band, a second radiator array for a second frequency band higher than the first frequency band, and a third radiator array for a third frequency band lower than the first frequency band are disposed, and radio frequency (RF) processing circuitry coupled to a side of the circuitry board. The first radiator array may include patch radiators having a first size, disposed on a first layer among a plurality of layers of the circuit board. The second radiator array may include patch radiators having a second size smaller than the first size, disposed on a second layer of the circuit board above the first layer with respect to the side of the circuit board among the plurality of layers of the circuit board. The third radiator array may include patch radiators having a third size larger than the first size, disposed on a third layer of the circuit board below the first layer with respect to the side of the circuit board among the plurality of layers of the circuit board. The patch radiators disposed on the second layer may be disposed to overlap the patch radiators disposed on the first layer, respectively. The patch radiators disposed on the third layer may include a patch radiator having a first patch portion partially overlapping with one of two adjacent patch radiators among the patch radiators disposed on the first layer and a second patch portion partially overlapping with another of the two adjacent patch radiators. A gap formed between the first patch portion and the second patch portion may be disposed on an area between the two adjacent patch radiators.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an example of an electronic device including an antenna module according to various embodiments;

FIG. 3 is a diagram illustrating an example of radiator arrays of an antenna module according to various embodiments;

FIGS. 4A, 4B, and 4C are diagrams illustrating an example of an antenna module including radiator arrays according to various embodiments;

FIG. 5 is a diagram illustrating a polarization direction of a radiator array in an antenna module according to various embodiments;

FIG. 6 is a diagram illustrating an electric field of patch portions of a radiator array in an antenna module according to various embodiments;

FIGS. 7A and 7B are diagrams illustrating an example of an antenna module including radiator arrays according to various embodiments;

FIGS. 8A and 8B are diagrams illustrating an example of an antenna module including radiator arrays according to various embodiments;

FIGS. 9A and 9B are cross-sectional views illustrating an example of an antenna module including radio frequency (RF) processing circuitry and radiator arrays according to various embodiments;

FIGS. 10A, 10B, and 10C are graphs illustrating an S-parameter for each radiator disposition structure according to various embodiments;

FIGS. 11A, 11B, and 11C are graphs illustrating radiation efficiency for each radiator disposition structure according to various embodiments;

FIGS. 12A and 12B are graphs illustrating polarization isolation for each radiator disposition structure according to various embodiments;

FIG. 13 includes diagrams illustrating examples of radiation patterns for each radiator array according to various embodiments;

FIGS. 14A and 14B are diagrams illustrating an example configuration of an electronic device including an antenna module according to various embodiments; and

FIGS. 15A and 15B are diagrams illustrating an example configuration of an electronic device including an antenna module according to various embodiments.

### DETAILED DESCRIPTION

Terms used in the present disclosure are used to describe various example embodiments, and is not intended to limit the scope of the disclosure. A singular expression may include a plural expression unless the context clearly indicates otherwise. Terms used herein, including a technical or a scientific term, may have the same meaning as those generally understood by one of ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

In the following description, terms used to refer to components of an electronic device (e.g., substrate, PCB (printed circuit board), FPCB (flexible PCB), PBA (printed board assembly), module, antenna element, circuit, processor, chip, component, or device), terms referring to antenna components (e.g., antenna element, antenna radiator, radiator, patch radiator, conductive part, conductive pattern, coil, conductive member, radiating member, radiating material, radiating component, antenna structure, antenna structure, feed part, feed member, RF (radio frequency) line, RF line structure, connecting member, connecting part, contact member), terms referring to the location of a component (e.g., part, location, area, point), terms referring to a physically separated space between one part and another (e.g., gap, slot, void, opening, hole), terms referring to the shape of a component (e.g., structure, structure, support, contact, or flange, protrusion), terms referring to connections between structures (e.g., connection, connecting part, contact, contact part, support, supporting part, connecting structure, supporting structure, contact structure, conductive member, conductive pad, conductive pattern, or assembly), terms referring to an open structure (e.g., slot, slit, or opening), and terms referring to a circuit (e.g., PCB, FPCB, signal line, ground line, feeding line, data line, RF signal line, antenna line, RF path, RF module, RF circuit, splitter, divider, coupler, or combiner) are provided as examples for convenience of explanation. Therefore, the present disclosure is not limited to the terms described below, and other terms having equivalent technical meanings may be used. Furthermore, terms such as ‘ . . . part’, ‘ . . . unit’, ‘ . . . material’, or ‘ . . . body’ used below may refer to at least one shape structure or a unit that processes a function.

In addition, in the present disclosure, the term ‘greater than’ or ‘less than’ may be used to determine whether a particular condition is satisfied or fulfilled, but this is simply a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ refer to including at least one of ‘C’ or ‘D’, that is, {′C′, ‘D’, and ‘C’ and ‘D’}.

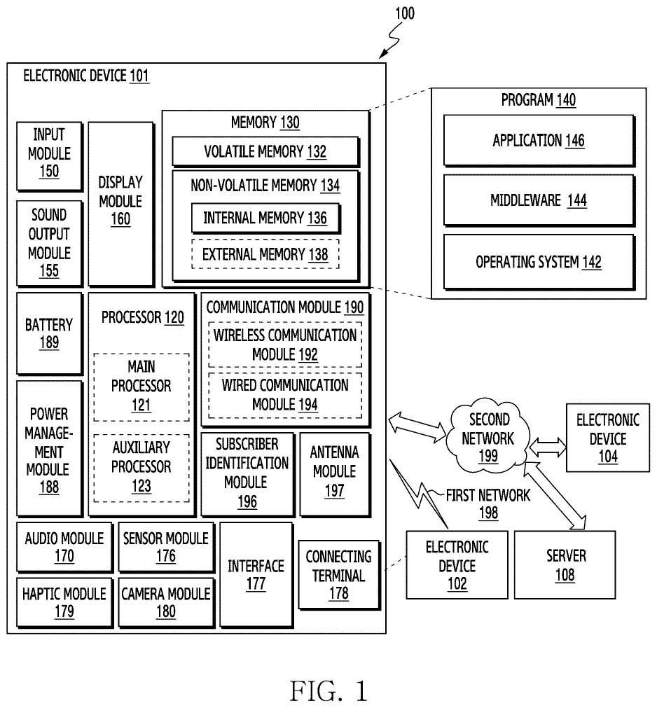

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

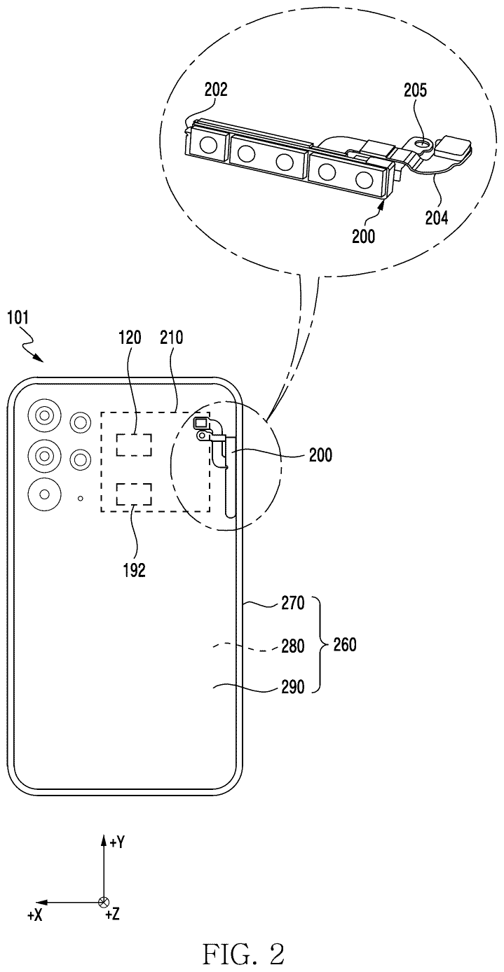

FIG. 2 is a diagram illustrating an example of an electronic device (e.g., the electronic device 101) including an antenna module according to various embodiments.

Referring to FIG. 2, the electronic device 101 may include an antenna module 200 (e.g., the antenna module 197 of FIG. 1). The electronic device 101 may perform wireless communication with an external electronic device (e.g., the electronic device 102, the electronic device 104, or the server 108) through the antenna module 200. The antenna module 200 may be electrically and/or operatively connected with a processor 120 and a wireless communication module 192 of the electronic device 101. For example, the electronic device 101 may include a flexible printed circuit board (FPCB) 204 for electrically connecting the antenna module 200 to the processor 120 and the wireless communication module 192 of the electronic device 101. The flexible printed circuit board 204 may electrically connect the antenna module 200 to a printed circuit board 210 of the electronic device 101. The processor 120 and a wireless communication module 192 may be disposed on the printed circuit board 210 of the electronic device 101, and the antenna module 200 may be electrically connected to the processor 120 and/or the wireless communication module 192 through the flexible printed circuit board 204 and the printed circuit board 210.

The electronic device 101 may include a housing 260. For example, the housing 260 may include a sidewall 270, a support portion 280, and a back cover 290. The support portion 280 may provide a structure for supporting or accommodating various components of the electronic device 101. For example, components of the electronic device 101 may be disposed on the support portion 280, such as the first printed circuit board 210 and the antenna module 200. The sidewall 270 may surround a periphery of the support portion 280 to at least partially form (or define) a lateral side of the electronic device 101. The back cover 290 may be seated on the sidewall 270 (and/or the support portion 280). The back cover 290 may cover an internal space of the electronic device 101 (e.g., the support part 280 or the components of the electronic device 101 disposed on the support part 280), and may at least partially form (or define) a rear side (e.g., a side facing a (−) z-axis) of the electronic device 101.

According to an embodiment, the antenna module 200 may be disposed in the housing 260 of the electronic device 101. For example, the antenna module 200 may be disposed adjacent to the sidewall 270. For example, the antenna module 200 may be disposed on the support portion 280 to face an inner surface of the sidewall 270.

The electronic device 101 according to an embodiment may include a bracket 202 for supporting and accommodating the antenna module 200. The bracket 202 may protect the antenna module 200 and maintain a position of the antenna module 200 at a fixed position by being fixed to the support part 280 in a state of accommodating the antenna module 200. For example, the bracket 202 may include a through hole 205 through which a fastener passes. The fastener may be coupled to the support portion 280 by passing through the through hole 205. For example, the fastener may include a screw, but is not limited thereto.

mmWave communication technology may quickly transmit large amounts of data by utilizing a high-frequency band (e.g., FR2 band, especially between about 24 GHz and about 39 GHz). The frequency band may provide a considerably wider bandwidth compared to an existing mobile network, and through this, a very high data transmission speed may be realized. However, due to a short wavelength length of a millimeter wave band, a propagation loss may be large and may be easily blocked by an obstacle. In order to address this problem, array antenna and beamforming technology configured with a plurality of elements are being applied to a base station and a terminal to reduce a signal loss. The antenna module (e.g., the antenna module 200) according to various embodiments of the present disclosure may support not only the mmWave band (e.g., the FR2 band) but also a frequency band (e.g., a band of about 7 GHz, a band of greater than or equal to 12.7 GHz and less than about 13.25 GHz, and a band of greater than or equal to about 14.8 GHz and less than about 15.35 GHz) of a new frequency range (e.g., FR3 of greater than or equal to 7.125 GHz and less than about 24.25 GHz). Through the frequency band of the new frequency range, a data transmission speed may be improved, and a delay time may be shortened. Since the frequency band has a smaller signal loss than the mmWave band, a wider signal reaching area may be provided.

The following table indicates a link budget between the electronic device 101 (e.g., UE) and the external electronic device (e.g., the base station (BS)) for each frequency band.

TABLE 1
User Equipment (UE) Specification

| Item | 7 GHz | | 12 GHz | | 15 GHz | | 28 GHz | |
|---|---|---|---|---|---|---|---|---|
| Free space path | 109 | | 114 | dB | 116 | dB | 121 | dB |
| loss(FSPL) @ 1 km | dB(decibel) | | | | | | | |
| A difference with | −12 | dB | −7 | dB | −5 | dB | 0 | dB |
| Path Loss @ 28 GHz | | | | | | | | |
| Wavelength | 42 | mm | 25 | mm | 20 | mm | 10 | mm |
| Number of Antennas | ~1 | ea | ~2 | ea. | ~2 | ea. | 5 | ea. |
| that may be mounted at | | | | | | | | |
| 25 mm (N) (N) | | | | | | | | |
| N Array Antenna | 1 | dB | 4 | dB | 4 | dB | 8 | dB |
| Gain (Antenna element | | | | | | | | |
| gain = 1 dB) | | | | | | | | |
| Uplink | 23 | | 20 | dBm | 20 | dBm | 14 | dBm |
| Transmission power | dBm(decibel- | | | | | | | |
| | milliwatts) | | | | | | | |
| Reception power @ | −85 | dBm | −90 | dBm | −92 | dBm | −99 | dBm |
| 1 km | | | | | | | | |

Baseband Station (BS) Specification

| item | 7 GHz | | 12 GHz | | 15 GHz | | 28 GHz | |
|---|---|---|---|---|---|---|---|---|
| Array Antenna Size | 4.2 cm × | | 5 cm × | | 8 cm × | | 8.6 cm × | |
| (Number of Antennas) | 8.4 cm | | 10 cm | | 8 cm | | 8.6 cm | |
| | (2 × 4) | | (4 × 8) | | (8 × 8) | | (16 × 16) | |
| Array Antenna | 10 | dB | 16 | dB | 19 | dB | 25 | dB |
| Gain(Antenna element | | | | | | | | |
| gain = 1 dB) | | | | | | | | |
| Downlink | 23 | dBm | 20 | dBm | 20 | dBm | 14 | dBm |
| Transmission Power | | | | | | | | |
| Reception Power @ | −76 | dBm | −77 | dBm | −77 | dBm | −82 | dBm |
| 1 km (Downlink, Cond. | | | | | | | | |
| power = 14 dBm) | | | | | | | | |

Referring to Table 1, it may be understood that a path loss compared to the 28 GHz band is more than 12 dB lower in the 7 GHz band, while the 12 GHz band and the 15 GHz band are improved by about 7 dB and about 5 dB, respectively. When the electronic device 101 transmits at a frequency of about 28 GHz, since reception power reaching the base station at a distance of about 1 km is very low, at about −99 dBm, it may be understood that a signal reach area of millimeter wave communication is very limited. According to an embodiment, the beamforming technology may be used to overcome a high path loss and provide a wider signal reach area than a millimeter wave. An array antenna having a plurality of antenna elements may be used for the beamforming technology. The antenna module 200 may include a plurality of antenna elements. The antenna module 200 may obtain a beamforming gain using the plurality of antenna elements. For example, the antenna module 200 may increase the beamforming gain and improve coverage by adjusting a difference between phases of RF signals applied to the plurality of antenna elements. The antenna module 200 may include antenna elements for each frequency band. The antenna module 200 according to various embodiments of the present disclosure may support various frequency bands. According to an embodiment, the antenna module 200 may support a first frequency band, a second frequency band, and a third frequency band. For example, the first frequency band may be a frequency band belonging to a frequency range (FR) 2 (e.g., greater than or equal to about 24.25 GHz). As an example, the first frequency band may include a frequency of about 26 GHz. For example, the second frequency band may be a frequency band belonging to FR2. As an example, the second frequency band may include a frequency of about 39 GHz. For example, the third frequency band may be a frequency band belonging to FR 3 (e.g., greater than or equal to about 7.125 GHz and less than about 24.25 GHz).

Although an electronic device in a bar-type is illustrated in FIG. 2, a form factor illustrated in FIG. 2 is merely illustrative, and the present disclosure is not limited thereto. Even if the device is an electronic device in a foldable type, a flip type, and/or a rollable type, it may be understood as an example embodiment of the present disclosure as long as it is the electronic device including the antenna module 200 to be described in greater detail below.

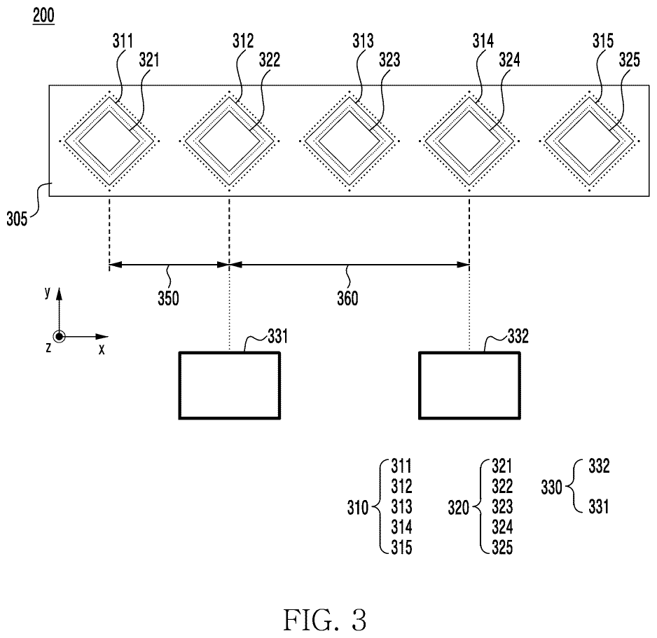

In FIG. 2, an example in which the antenna module 200 is disposed in the electronic device 101, which is a terminal for communicating with a network, has been described, but the present disclosure is not limited thereto. A structure according to various embodiments of the present disclosure to be described in greater detail below may be applied not only to the electronic device 101 but also to an antenna module in base station equipment (e.g., a base station, or a radio unit (RU) of the base station) for communicating with the electronic device 101. The base station equipment supporting a plurality of frequency bands may include an antenna module having a module structure according to descriptions of FIGS. 3 to 9B.

FIG. 3 is a diagram illustrating an example of radiator arrays of an antenna module (e.g., the antenna module 200) according to various embodiments. An array antenna may be used for beamforming technology. The array antenna may include antenna elements. Each antenna element may include a radiator. Radiators may be disposed at spacing of about 0.5 (e.g., 0.5λ, λ is a length of a wavelength) of the wavelength (e.g., a free space wavelength). The disposition of the radiators may be referred to as a radiator array.

Referring to FIG. 3, the antenna module 200 may include a circuit board 305 (e.g., a printed circuit board (PCB)) and radiator arrays included in the circuit board 305. The radiator arrays may include a first radiator array 310 for a first frequency band, a second radiator array 320 for a second frequency band, and a third radiator array 330 for a third frequency band. For example, the first frequency band may belong to a frequency range (FR) 2 (e.g., greater than or equal to about 24.25 GHz). The second frequency band may belong to FR2. A frequency of the second frequency band may be higher than a frequency of the first frequency band. As an example, the first frequency band may include a frequency of about 28 GHz. The second frequency band may include a frequency of about 39 GHz. The third frequency band may belong to FR 3 (e.g., greater than or equal to about 7.125 GHz and less than about 24.25 GHz). A frequency of the third frequency band may be lower than the frequency of the first frequency band. As a non-limiting example, the third frequency band may be about 12 GHz band or about 15 GHz band of Table 1.

The circuit board 305 may include a plurality of layers. A conductive portion (e.g., metal) formed in each layer may be used as an antenna radiator. For example, the conductive portion may have a patch shape. The first radiator array 310 may include patch radiators. For example, the patch radiators of the first radiator array 310 may be disposed according to a 1×5 disposition. The patch radiators of the first radiator array 310 may include a 1-1 patch radiator 311, a 1-2 patch radiator 312, a 1-3 patch radiator 313, a 1-4 patch radiator 314, and/or a 1-5th patch radiator 315. The second radiator array 320 may include patch radiators. For example, the patch radiators of the second radiator array 320 may be disposed according to a 1×5 disposition. The patch radiators of the second radiator array 320 may include a 2-1 patch radiator 321, a 2-2 patch radiator 322, a 2-3 patch radiator 323, a 2-4 patch radiator 324, and/or a 2-5 patch radiator 325. The third radiator array 330 may include patch radiators. For example, the patch radiators of the third radiator array 330 may be disposed according to a 1×2 disposition. The patch radiators of the third radiator array 330 may include a 3-1 patch radiator 331 and/or a 3-2 patch radiator 332.

An operating frequency of a signal and a wavelength of the signal are inversely proportional to each other. A patch radiator may be designed to have a size (e.g., half wavelength) proportional to the wavelength of the operating frequency in order to efficiently emit or receive a radio wave through resonance. A size of the patch radiators of the first radiator array 310 for the first frequency band (e.g., about 28 GHz band) may be larger than a size of the patch radiators of the second radiator array 320 for the second frequency band (e.g., about 39 GHz band). A size of the patch radiators of the third radiator array 330 may be larger than the size of the patch radiators of the first radiator array 310. The patch radiators of the first radiator array 310 for the first frequency band (e.g., about 28 GHz band) and the patch radiators of the second radiator array 320 for the second frequency band (e.g., about 39 GHz band) may be disposed to overlap. The antenna module 200 may function as a dual-band stacked antenna. According to an embodiment, when viewing the antenna module 200 in a direction (e.g., a (−) z axis), the patch radiator of the second radiator array 320 may be fully overlapped with the patch radiator of the first radiator array 310. For example, the 2-1 patch radiator 321 of the second radiator array 320 may be disposed to be fully overlapped with the 1-1 patch radiator 311 of the first radiator array 310. In a stacked shape in a direction (e.g., a (+) z-axis direction), the 2-1 patch radiator 321 having a smaller size may be disposed on an upper layer (e.g., in which a z-axis coordinate is larger) and the 1-1 patch radiator 311 having a larger size may be disposed on a lower layer (e.g., in which the z-axis coordinate is smaller). For example, the 2-2 patch radiator 322 of the second radiator array 320 may be disposed to be fully overlapped with the 1-2 patch radiator 312 of the first radiator array 310. In the stacked shape in the direction (e.g., the (+) z-axis direction), the 2-2 patch radiator 322 having a smaller size may be disposed on the upper layer (e.g., in which the z-axis coordinate is larger) and the 1-2 patch radiator 312 having a larger size may be disposed on the lower layer (e.g., in which the z-axis coordinate is smaller). For example, the 2-3 patch radiator 323 of the second radiator array 320 may be disposed to be fully overlapped with the 1-3 patch radiator 313 of the first radiator array 310. In the stacked shape in the direction (e.g., the (+) z-axis direction), the 2-3 patch radiator 323 having a smaller size may be disposed on the upper layer (e.g., in which the z-axis coordinate is larger) and the 1-3 patch radiator 313 having a larger size may be disposed on the lower layer (e.g., in which the z-axis coordinate is smaller). For example, the 2-4 patch radiator 324 of the second radiator array 320 may be disposed to be fully overlapped with the 1-4 patch radiator 314 of the first radiator array 310. In the stacked shape in the direction (e.g., the (+) z-axis direction), the 2-4 patch radiator 324 having a smaller size may be disposed on the upper layer (e.g., in which the z-axis coordinate is larger) and the 1-4 patch radiator 314 having a larger size may be disposed on the lower layer (e.g., in which the z-axis coordinate is smaller). For example, the 2-5 patch radiator 325 of the second radiator array 320 may be disposed to be fully overlapped with the 1-5 patch radiator 315 of the first radiator array 310. In the stacked shape in the direction (e.g., the (+) z-axis direction), the 2-5 patch radiator 325 having a smaller size may be disposed on the upper layer (e.g., in which the z-axis coordinate is larger) and the 1-5 patch radiator 315 having a larger size may be disposed on the lower layer (e.g., in which the z-axis coordinate is smaller).

Frequencies of the third frequency band may be lower than frequencies of the first frequency band (e.g., about 28 GHz). The size of the patch radiators (e.g., the 3-1 patch radiator 331 or the 3-2 patch radiator 332) of the third radiator array 330 may be larger than the size of the patch radiators (e.g., the 1-1 patch radiator 311, the 1-2 patch radiator 312, the 1-3 patch radiator 313, the 1-4 patch radiator 314, or the 1-5 patch radiator 315) of the first radiator array 310. The frequencies of the third frequency band may be lower than frequencies of the second frequency band. The size of the patch radiators (e.g., the 3-1 patch radiator 331 or the 3-2 patch radiator 332) of the third radiator array 330 may be larger than the size of the patch radiators (e.g., the 2-1 patch radiator 321, the 2-2 patch radiator 322, the 2-3 patch radiator 323, the 2-4 patch radiator 324 and the 2-5 patch radiator 325) of the second radiator array 320. For example, in a case that the first frequency band is about 24 GHz and the third frequency band is about 12 GHz, the size of the patch radiators of the third radiator array 330 may be about twice the size of the patch radiators of the first radiator array 310. As an example, in a case that the first frequency band is about 24 GHz and the third frequency band is about 12 GHz, the size of the patch radiators of the third radiator array 330 may be about twice the size of the patch radiators of the first radiator array 310. As an example, in a case that the second frequency band is about 39 GHz and the third frequency band is about 15 GHz, the size of the patch radiators of the third radiator array 330 may be about 2.6 times the size of the patch radiators of the second radiator array 330.

Spacing between the antenna elements (e.g., the patch radiators) in the array antenna may be designed to be proportional to a wavelength according to a frequency. For example, if the spacing between the antenna elements is designed to be substantially less than or equal to half the wavelength, signals emitted by each antenna element may be synthesized to concentrate in a specific direction. As a sidelobe may be suppressed, directivity may be improved. On the other hand, if the spacing between the antenna elements is substantially greater than or irregular than the wavelength, interference between signals may cause the sidelobe and a radiation pattern may be distorted. Since the array antenna mainly includes the antenna elements disposed at spacing of about half the wavelength of each frequency, the spacing between the antenna elements may increase as the operating frequency decreases. For example, spacing (e.g., a second length 360) between the patch radiators of the third radiator array 330 for the third frequency band (e.g., a frequency band in a range greater than or equal to about 7.125 GHz and less than about 24.25 GHz) may be longer than spacing (e.g., a first length 350) between the patch radiators of the first radiator array 310 for the first frequency band (e.g., a frequency band of about 29 GHz in FR2). For example, the spacing between the patch radiators of the first radiator array 310 may be the first length 350. As an example, in a case that the first frequency band is a frequency band of about 30 GHz, the first length 350 may be a half wavelength λ/2 and have a length of about 5 mm. Spacing between the patch radiators of the second radiator array 320 may be the first length 350 (e.g., about 350 nm). As an example, in a case that the second frequency band is a frequency band of about 39 GHz, the first length 350 may be 0.65λ and have a length of about 5 mm. For example, the spacing between the patch radiators of the third radiator array 330 may be the second length 360. As an example, in a case that the third frequency band is a frequency band of about 15 GHz, the second length 360 may be a half wavelength λ/2 and have a length of about 10 mm.

In an embodiment, the third radiator array 330 may include the 3-1 patch radiator 331 and the 3-2 patch radiator 332. Spacing between the 3-1 patch radiator 331 and the 3-2 patch radiator 332 may correspond to the second length 360. If the 3-1 patch radiator 331 or the 3-2 patch radiator 332 is disposed to overlap the patch radiator (e.g., the 1-1 patch radiator 311, the 1-2 patch radiator 312, the 1-3 patch radiator 313, the 1-4 patch radiator 314, or the 1-5 patch radiator 315) for the first frequency band, a portion of the antenna elements of the antenna array may function as a double-band antenna and another portion of the antenna elements of the antenna array may function as a triple-band antenna. For example, the 3-1 patch radiator 331 may be disposed to overlap the 1-1 patch radiator 311, and the 3-2 patch radiator 332 may be disposed to overlap the 1-2 patch radiator 312. Likewise, the 3-1 patch radiator 331 may be disposed to overlap the 2-1 patch radiator 321, and the 3-2 patch radiator 332 may be disposed to overlap the 2-2 patch radiator 322. Radiation efficiency of the 3-1 patch radiator 331 may be reduced due to the 1-1 patch radiator 311 and/or the 2-1 patch radiator 321 that are disposed to overlap. Radiation efficiency of the 3-2 patch radiator 332 may be reduced due to the 1-2 patch radiator 312 and/or the 2-2 patch radiator 322 that are disposed to overlap. In addition, in a case that signals of the first frequency band are radiated through the first radiator array 310, radiation characteristics of the 1-1 patch radiator 311 and the 1-2 patch radiator 312 and radiation characteristics of the 1-3 patch radiator 313, the 1-4 patch radiator 314, and the 1-5 patch radiator 315 may be different from each other. For another example, the 3-1 patch radiator 331 may be disposed to overlap the 1-2 patch radiator 312, and the 3-2 patch radiator 332 may be disposed to overlap the 1-4 patch radiator 314. In a case that signals of the first frequency band are radiated through the first radiator array 310, radiation characteristics of the 1-2 patch radiator 312 and the 1-4 patch radiator 314 and radiation characteristics of the 1-1 patch radiator 311, the 1-3 patch radiator 313, and the 1-5 patch radiator 315 may be different from each other.

In other words, a radiation characteristic of each of the patch radiators of the first radiator array 310 may not be uniform. A radiation characteristic of each of the patch radiators of the second radiator array 320 may not be uniform. Since a beamforming gain varies for each patch radiator and a difference in phase increases due to the different characteristics, beamforming performance may be reduced, and a bandwidth may be narrower. In a case that a patch radiator functions as a double polarization antenna in the FR2 band (e.g., the first frequency band or the second frequency band), polarization isolation may be reduced. In the various example embodiments of the present disclosure, to address the above-described problem, a description of a disposition structure of the patch radiators (e.g., the 3-1 patch radiator 331 or the 3-2 patch radiator 332) of the third radiator array 330 in the circuit board 305 of the antenna module 200 and a shape of each patch radiator are described.

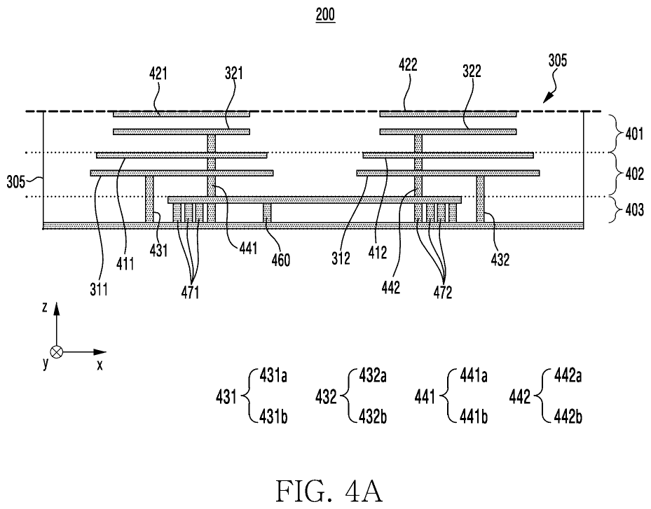

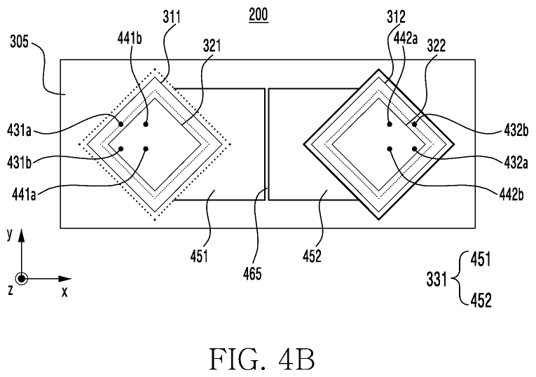

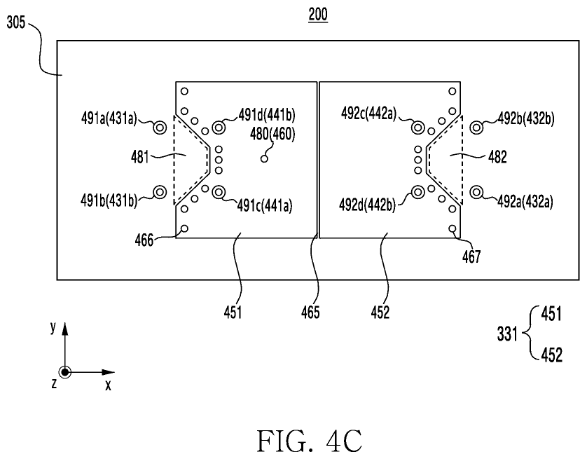

FIGS. 4A, 4B, and 4C are diagrams illustrating an example of an antenna module (e.g., the antenna module 200) including radiator arrays (e.g., the first radiator array 310, the second radiator array 320, or the third radiator array 330) according to various embodiments. In order to describe a patch radiator for a third frequency band (e.g., a frequency band of FR3 greater than or equal to about 7.125 GHz and less than about 24.25 GHz, a band of about 12 GHz, or a band of about 15 GHz), two patch radiators for a first frequency band (e.g., a frequency band of FR2 greater than or equal to about 24.25 GHz, a band of about 26 GHz, or a band of about 28 GHz) and two patch radiators for a second frequency band (e.g., a frequency band of FR2 greater than or equal to about 24.25 GHz, or a band of about 39 GHz) are described as an example. However, the present disclosure is not limited thereto. The first radiator array 310 may include more than two patch radiators. The second radiator array 320 may include more than two patch radiators. The third radiator array 330 may include a plurality of patch radiators.

Referring to FIGS. 4A and 4B, in the antenna module 200, a circuit board 305 may include a plurality of layers. A conductive portion may be formed in at least one of the plurality of layers. The conductive portion may function as a radiator of an antenna. As the conductive portion has a patch shape, the radiator may be referred to as a patch radiator. For example, the layers of the circuit board 305 may include a first set of layers 401, a second set of layers 402, and a third set of layers 403. The first set of layers 401 may be positioned above the third set of layers 403 with respect to a side (e.g., an xy plane). The second set of layers 402 may be positioned above the third set of layers 403 with respect to the side (e.g., the xy plane).

According to an embodiment, patch radiators for the first frequency band (e.g., the frequency band of FR2 greater than or equal to about 24.25 GHz, the band of about 26 GHz, or the band of about 28 GHz) may be disposed on the second set of layers 402 among the layers of the circuit board 305. For example, patch radiators (e.g., the 1-1 patch radiator 311, the 1-2 patch radiator 312, the 1-3 patch radiator 313, the 1-4 patch radiator 314, or the 1-5 patch radiator 315 of FIG. 3) may be disposed on a first layer among the second set of layers 402. The 1-1 patch radiator 311 may be connected to a feeding portion 431. The feeding portion 431 may include a conductive structure (e.g., a via, or a line) for transmitting RF signals processed through RF processing circuitry to the 1-1 patch radiator 311. In an embodiment, an antenna (an individual antenna of an array antenna) including the 1-1 patch radiator 311 may support double polarization. For example, the feeding portion 431 may include a first feeding portion 431a for a first polarization and a second feeding portion 431b for a second polarization. The first polarization and the second polarization may be orthogonal to each other. As an example, the first polarization may be vertical polarization, and the second polarization may be horizontal polarization. For example, the first polarization may be (+) 45 degrees polarization, and the second polarization may be (−) 45 degrees polarization. The first feeding portion 431a may be used to provide signals having the first polarization to the 1-1 patch radiator 311. The second feeding portion 431b may be used to provide signals having the second polarization to the 1-1 patch radiator 311. As a non-limiting example, when viewing the antenna module 200 in a direction (e.g., a (+) y-axis direction), the first feeding portion 431a and the second feeding portion 431b may be disposed to overlap. For example, in order to increase a bandwidth or a radiation gain through coupling, a 1-1 additional patch radiator 411 may be disposed on a layer at a higher position (e.g., a position with a larger coordinate on a z-axis or a (+) z-axis direction) than the first layer. The 1-1 additional patch radiator 411 may be configured to emit signals through coupling with the 1-1 patch radiator 311. As an example, the 1-1 additional patch radiator 411 may be referred to as a parasitic patch. The 1-2 patch radiator 312 may be connected to a feeding portion 432. For example, the feeding portion 432 may include a first feeding portion 432a for a first polarization and a second feeding portion 432b for a second polarization. For example, in order to increase a bandwidth or increase a radiation gain through coupling, a 2-1 additional patch radiator 412 may be disposed on a layer at a higher position (e.g., a position with a larger coordinate on the z-axis or the (+) z-axis direction) than the first layer. The 2-1 additional patch radiator 412 may be configured to emit signals through coupling with the 1-2 patch radiator 312.

According to an embodiment, patch radiators for the second frequency band (e.g., the frequency band of FR2 greater than or equal to about 24.25 GHz, the band of about 39 GHz) may be disposed on the first set of layers 401 among the layers of the circuit board 305. For example, patch radiators (e.g., the 2-1 patch radiator 321, the 2-2 patch radiator 322, the 2-3 patch radiator 323, the 2-4 patch radiator 324, or the 2-5 patch radiator 325 of FIG. 3) may be disposed on a second layer among the first set of layers 401. The 2-1 patch radiator 321 may be connected to a feeding portion 441. The feeding portion 441 may include a conductive structure (e.g., a via, or a line) for transmitting RF signals processed through the RF processing circuitry to the patch radiator. In an embodiment, an antenna including the 2-1 patch radiator 321 may support double polarization. For example, the feeding portion 441 may include a first feeding portion 441a for a first polarization and a second feeding portion 441b for a second polarization. The first polarization and the second polarization may be orthogonal to each other. As an example, the first polarization may be a vertical polarization, and the second polarization may be a horizontal polarization. For example, the first polarization may be a (+) 45 degrees polarization, and the second polarization may be a (−) 45 degrees polarization. The first feeding portion 441a may be used to provide signals having the first polarization to the 2-1 patch radiator 321. The second feeding portion 441b may be used to provide signals having the second polarization to the 2-1 patch radiator 321. As a non-limiting example, when viewing the antenna module 200 in a direction (e.g., the (+) y-axis direction), the first feeding portion 441a and the second feeding portion 441b may be disposed to overlap. For example, in order to increase a bandwidth or increase a radiation gain through coupling, a 1-2 additional patch radiator 421 may be disposed on a second layer at a higher position (e.g., the position with the larger coordinate on the z-axis or the (+) z-axis direction) than the first layer. The 1-2 additional patch radiator 421 may be configured to emit signals through coupling with the 2-1-th patch radiator 321. As an example, the 1-2 additional patch radiator 421 may be referred to as a parasitic patch. The 2-2 patch radiator 322 may be connected to a feeding portion 442. For example, the feeding portion 442 may include a first feeding portion 442a for the first polarization and a second feeding portion 442b for the second polarization. For example, in order to increase a bandwidth or increase a radiation gain through coupling, the 2-2 additional patch radiator 422 may be disposed on a layer at a higher position (e.g., a position with a larger coordinate on the z-axis or the (+) z-axis direction) than the second layer. The 2-2 additional patch radiator 422 may be configured to emit signals through coupling with the 2-2 patch radiator 322.

According to an embodiment, patch radiators for the third frequency band (e.g., the frequency band of FR3 greater than or equal to about 7.125 GHz and less than about 24.25 GHz, the band of about 12 GHz, or the band of about 15 GHz) may be disposed on the third set of layers 403 among the layers of the circuit board 305. For example, patch radiators (e.g., the 3-1 patch radiator 331 and the 3-2 patch radiator 332 of the third radiator array 330 of FIG. 3) may be disposed on a third layer among the third set of layers 403. The 3-1 patch radiator 331 may be connected to a feeding portion 460. The feeding portion 460 may include a conductive structure (e.g., a via, or a line) for transmitting RF signals processed through RF processing circuitry to the patch radiator. The 3-1 patch radiator 331 may be connected to conductive vias connected to a ground. For example, the conductive vias may include a first set 471 of conductive vias and a second set 472 of conductive vias. The 3-1 patch radiator 331 may include a first patch portion (e.g., a first patch portion 451 of FIG. 4B) and a second patch portion (e.g., a second patch portion 452 of FIG. 4B) that are distinguished with respect to an axis (e.g., a y-axis). For example, the first set 471 of conductive vias may be used to connect the first patch portion 451 to the ground (e.g., a ground layer of the circuit board 305). For example, the second set 472 of conductive vias may be used to connect the second patch portion 452 to the ground (e.g., the ground layer of the circuit board 305).

Referring to FIG. 4B, when viewing the antenna module 200 in a direction (e.g., a (−) z axis direction), the 3-1 patch radiator 331 of the third radiator array 330 may include the first patch portion 451 and the second patch portion 452 that are distinguished with respect to the axis (e.g., the y axis) of a plane (e.g., the xy plane). A gap 465 may be formed between the first patch portion 451 and the second patch portion 452. According to an embodiment, the 3-1 patch radiator 331 of the third radiator array 330 may be disposed to overlap both of two adjacent patch radiators (e.g., the 1-1 patch radiator 311 and the 1-2 patch radiator 312) of the first radiator array 310. For example, the first patch portion 451 may be disposed to partially overlap the 1-1 patch radiator 311 of the first radiator array 310 when viewing the antenna module 200 in the direction (e.g., the (−) z-axis direction). The second patch portion 452 may be disposed to partially overlap the 1-2 patch radiator 312 of the first radiator array 310 when viewing the antenna module 200 in a direction (e.g., a stacking direction of the layers of the circuit board 305, or the (−) z-axis direction). In addition, the 3-1 patch radiator 331 of the third radiator array 330 may be disposed to overlap both of two adjacent patch radiators (e.g., the 2-1 patch radiator 321 and the 2-2 patch radiator 322) of the second radiator array 320. For example, the first patch portion 451 may be disposed to partially overlap the 2-1 patch radiator 321 of the second radiator array 320 when viewing the antenna module 200 in the direction (e.g., the stacking direction of the layers of the circuit board 305, or the (−) z-axis direction). The second patch portion 452 may be disposed to partially overlap the 2-2 patch radiator 322 of the second radiator array 320 when viewing the antenna module 200 in the direction (e.g., the (−) z axis direction).

According to an embodiment, an area (hereinafter, a center area) including a center of the 3-1 patch radiator 331 may be positioned in an area between the 1-1 patch radiator 311 and the 1-2 patch radiator 312. For example, the 3-1 patch radiator 331 may be disposed such that the center area does not overlap with the 1-1 patch radiator 311 and the 1-2 patch radiator 312, respectively. The gap 465 may be formed in the center area of the first patch portion 451 and the second patch portion 452 of the 3-1 patch radiator 331. The 3-1 patch radiator 331 may be disposed such that the gap 465 is positioned in the area between the 1-1 patch radiator 311 and the 1-2 patch radiator 312. Signals of the third frequency band (e.g., the frequency band of FR3 greater than or equal to about 7.125 GHz and less than about 24.25 GHz, the band of about 12 GHz, or the band of about 15 GHz) may be provided to the first patch portion 451 of the 3-1 patch radiator 331 through the feeding portion 460. At least a portion of the signals radiated through the first patch portion 451 may be provided to the second patch portion 452 through coupling. The second patch portion 452, which is a parasitic patch, may be configured to emit the signals of the third frequency band. While the first patch portion 451 and the second patch portion 452 respectively radiate signals, the signals may be concentrated in an area (e.g., an area adjacent to the gap 465 among the first patch portion 451, or an area adjacent to the gap 465 among the second patch portion 452) adjacent to the gap 465. Since the 1-1 patch radiator 311 and the 1-2 patch radiator 312 are not positioned above the gap 465 with respect to a direction (e.g., the (+) z-axis direction), a radiation gain in the area adjacent to the gap 465 may be improved. In other words, since an influence of the 1-1 patch radiator 311 and the 1-2 patch radiator 312 as obstacles is reduced in a radiation direction (e.g., the (+) z axis direction or a direction adjacent to the (+) z axis) of the signals, radiation efficiency of the 3-1 patch radiator 331 may increase.

Referring to FIG. 4C, the electronic device 101 may include the circuit board 305. The circuit board 305 may include patch radiators of the third radiator array 330. The third radiator array 330 may include the 3-1 patch radiator 331. The 3-1 patch radiator 331 may include the first patch portion 451 and the second patch portion 452. The first patch portion 451 and the second patch portion 452 may form the gap 465. According to an embodiment, the first patch portion 451 and the second patch portion 452 may be disposed symmetrically with respect to an axis (e.g., the (+) y axis) related to the gap 465 between the first patch portion 451 and the second patch portion 452.

In an embodiment, the antenna module 200 may support double polarization (e.g., the vertical polarization and the horizontal polarization, of the (+) 45 degrees polarization and the (−) 45 degrees polarization). A gain according to polarization diversity may be obtained by transmitting signals having polarizations orthogonal to each other. For example, RF signals may be provided to an antenna for the first frequency band (e.g., the frequency band of FR2 greater than or equal to about 24.25 GHz, the band of about 26 GHz, or the band of about 28 GHz), through two ports. The RF signals may include a signal having a first polarization from a first port and a signal having a second polarization from a second port. For example, RF signals may be provided to an antenna for the second frequency band (e.g., the frequency band of FR2 greater than or equal to about 24.25 GHz, the band of about 39 GHz), through two ports. The RF signals may include a signal having a first polarization from a third port and a signal having a second polarization from a fourth port.

A position at which the RF signal is fed within a patch radiator may vary according to a polarization. When viewing the antenna module 200 in a direction (e.g., the (−) z-axis direction), a plurality of points for feeding may be positioned on a side of the circuit board 305. According to an embodiment, for a uniform radiation characteristic between antenna elements of the array antenna, feeding positions of the RF signal may be designed symmetrically. For example, the circuit board 305 may include the patch radiators (e.g., the 1-1 patch radiator 311, the 1-2 patch radiator 312, the 1-3 patch radiator 313, the 1-4 patch radiator 314, or the 1-5 patch radiator 315) of the first radiator array 310. As an example, the first feeding portion 431a for providing a signal having the first polarization to the 1-1 patch radiator 311 may be formed along a direction (e.g., the (+) z-axis direction) from a point 491a on a side (e.g., which is a side parallel to the xy plane, a layer connected to the ground layer or a RF line) of the circuit board 305. The second feeding portion 431b for providing a signal having the second polarization may be formed along the direction (e.g., the (+) z-axis direction) from a point 491b on the side (e.g., which is the side parallel to the xy plane, the layer connected to the ground layer or the RF line) of the circuit board 305. As an example, the first feeding portion 432a for providing a signal having the first polarization to the 1-2 patch radiator 312 may be formed in the direction (e.g., the (+) z-axis direction) from a point 492a on the side (e.g., which is the side parallel to the xy plane, the layer connected to the ground layer or the RF line) of the circuit board 305. The second feeding portion 432b for providing a signal having the second polarization may be formed along the direction (e.g., the (+) z-axis direction) from a point 492b on the side (e.g., which is the side parallel to the xy plane, the layer connected to the ground layer or the RF line) of the circuit board 305. For example, the circuit board 305 may include the patch radiators (e.g., the 2-1 patch radiator 321, the 2-2 patch radiator 322, the 2-3 patch radiator 323, the 2-4 patch radiator 324, or the 2-5 patch radiator 325) of the second radiator array 320. As an example, the first feeding portion 441a for providing a signal having the first polarization to the 2-1 patch radiator 321 may be formed along the direction (e.g., the (+) z-axis direction) from a point 491c on the side (e.g., which is the side parallel to the xy plane, the layer connected to the ground layer or the RF line) of the circuit board 305. The second feeding portion 441b for providing a signal having the second polarization may be formed along the direction (e.g., the (+) z-axis direction) from a point 491d on the side (e.g., which is the side parallel to the xy plane, the layer connected to the ground layer or the RF line) of the circuit board 305. As an example, the first feeding portion 442a for providing a signal having the first polarization to the 2-2 patch radiator 322 may be formed in the direction (e.g., the (+) z-axis direction) from a point 492c on the side (e.g., which is the side parallel to the xy plane, the layer connected to the ground layer or the RF line) of the circuit board 305. The second feeding portion 442b for providing a signal having the second polarization may be formed along the direction (e.g., the (+) z-axis direction) from a point 492d on the side (e.g., which is the side parallel to the xy plane, the layer connected to the ground layer or the RF line) of the circuit board 305.

According to an embodiment, each of the patch radiators (e.g., the 3-1 patch radiator 331 or the 3-2 patch radiator 332) of the third radiator array 330 may have a shape in which a notch is formed at both ends. For example, the 3-1 patch radiator 331 may include the first patch portion 451 and the second patch portion 452. The first patch portion 451 may have a shape in which a notch is formed on a side (e.g., a side facing a (−) x axis). As an example, the first patch portion 451 may have a shape in which a cutting area 481 partially overlapping with another radiator (e.g., the 1-1 patch radiator 311 or the 2-1 patch radiator 321) is removed from a polygon (e.g., a quadrangle). The cutting area 481 may be referred to as a notch. The second patch portion 452 may have a shape in which a notch is formed on a side (e.g., a side facing a (+) x-axis). As an example, the second patch portion 452 may have a shape in which a cutting area 482 partially overlapping with another radiator (e.g., the 1-2 patch radiator 312 or the 2-2 patch radiator 322) is removed from a polygon (e.g., a quadrangle). The cutting area 482 may be referred to as a notch. In an embodiment, according to the shape of the first patch portion 451 and the second patch portion 452, a radiation characteristic (e.g., polarization isolation) of the first radiator array 310 and a radiation characteristic (e.g., polarization isolation) of the second radiator array 320 may be improved. In an embodiment, according to the shape of the first patch portion 451 and the second patch portion 452, a radiation characteristic (e.g., radiation efficiency) of the 3-1 patch radiator 331 may be improved.

According to an embodiment, the patch radiators (e.g., the 3-1 patch radiator 331 or the 3-2 patch radiator 332) of the third radiator array 330 may include conductive vias connected to the ground (e.g., the ground layer of the circuit board 305). The conductive vias may include the first set 471 of conductive vias and the second set 472 of conductive vias. For example, the first patch portion 451 of the 3-1 patch radiator 331 may be connected to each conductive via of the first set 471 of conductive vias. For example, at points (e.g., a point 466) formed along an end (e.g., an area facing the (−) y-axis) of the first patch portion 451, the first patch portion 451 may be connected to each conductive via of the first set 471 of conductive vias. For example, the second patch portion 452 of the 3-1 patch radiator 331 may be connected to each conductive via of the second set 472 of conductive vias. For example, at points (e.g., a point 467) formed along an end (e.g., an area facing the (+) y-axis) of the second patch portion 452, the second patch portion 452 may be connected to each conductive via of the second set 472 of conductive vias.

In FIGS. 4A, 4B, and 4C, the gap 465 has been illustrated as a gap for fully separating the first patch portion 451 and the second patch portion 452 of the 3-1 patch radiator 331, but the present disclosure is not limited thereto. Rather than separating the first patch portion 451 and the second patch portion 452, an opening (slot) formed inside a single integrally formed patch or a slit formed on a side of the patch may also be understood as an example of the gap 465.

An antenna module (e.g., the antenna module 200) according to various example embodiments of the present disclosure may have a structure for efficiently disposing radiator arrays supporting different frequency bands. A position of each radiator of a radiator array (e.g., the first radiator array 310) supporting a specific frequency band may affect performance of a radiator array (e.g., the first radiator array 310 or the second radiator array 320) supporting another specific frequency band. Since spacing between radiators and a size of each radiator in the radiator array are designed in proportion to a wavelength, a radiator of a radiator array supporting a low frequency band (e.g., the frequency band of FR3 greater than or equal to about 7.125 GHz and less than about 24.25 GHz, the band of about 12 GHz, or the band of about 15 GHz) may be required to be disposed between radiators of a radiator array supporting a high frequency band (e.g., a frequency band of FR2). The antenna module 200 according to various example embodiments of the present disclosure may have a structural disposition between radiator arrays for these different frequency bands.

In FIGS. 4A, 4B and 4C (which may be referred to as FIGS. 4A to 4C), radiators formed on layers of a circuit board (e.g., the circuit board 305) have been described as an example, but the present disclosure is not limited thereto. According to an embodiment, radiators of radiator arrays (e.g., the first radiator array 310, the second radiator array 320, or the third radiator array 330) may be spaced apart from a side of the circuit board 305 by predetermined spacing. For example, the radiators of the first radiator array 310 may be disposed by being spaced apart from the side of the circuit board 305 by a first length. The radiators of the second radiator array 320 may be disposed by being spaced apart from the surface of the circuit board 305 by a second length. The second length may be longer than the first length. A feeding portion connected to each radiator may include a separate feeding structure (e.g., a feeding bridge) disposed on the side of the circuit board 305 instead of a via in the circuit board 305. The radiators of the third radiator array 330 may be disposed by being spaced apart from the surface of the circuit board 305 by a third length. The third length may be shorter than the first length. The radiators of the third radiator array 330 may be disposed to have a lower height than the radiators of the first radiator array 310. In addition, each of the radiators (e.g., the 3-1 patch radiator 331 or the 3-2 patch radiator 332) of the third radiator array 330 may be disposed to overlap between radiators of another radiator array. As a non-limiting example, an individual radiator and a feeding portion in a radiator array may correspond to an integrally formed metal structure.

According to an embodiment, at least a portion of radiators of radiator arrays (e.g., the first radiator array 310, the second radiator array 320, or the third radiator array 330) may be disposed above the circuit board 305 through a separate feeding member separate from the circuit board 305 rather than a layer in the circuit board 305. As a non-limiting example, the radiators (e.g., the 1-1 patch radiator 311, the 1-2 patch radiator 312, the 1-1 additional patch radiator 411, or the 2-1 additional patch radiator 412) of the first radiator array 310 and the radiators (e.g., the 3-1 patch radiator 331, or the 3-2 patch radiator 332) of the third radiator array 330 are disposed on the layers within the circuit board 305, and the radiators (e.g., the 2-1 patch radiator 321, the 2-1 additional patch radiator 322, the 1-2 additional patch radiator 421, and the 2-2 additional patch radiator 422) of the second radiator array 320 may be disposed outside the circuit board 305. Each of the radiators of the second radiator array 320 may be connected to a separate feeding structure disposed on the circuit board 305. As a non-limiting example, the radiators (e.g., the 3-1 patch radiator 331, or the 3-2 patch radiator 332) of the third radiator array 330 may be disposed on the layers within the circuit board 305, and the radiators (e.g., the 1-1 patch radiator 311, the 1-2 patch radiator 312, the 1-1 additional patch radiator 411, or the 2-1 additional patch radiator 412) of the first radiator array 310 and the radiators (e.g., the 2-1 patch radiator 321, the 2-1 additional patch radiator 322, the 1-2 additional patch radiator 421, and the 2-2 additional patch radiator 422) of the second radiator array 320 may be disposed outside the circuit board 305. Each of the radiators of the first radiator array 310 and the radiators of the second radiator array 320 may be connected to a separate feeding structure disposed on the circuit board 305. As an example, as an antenna module of communication equipment (e.g., a base station, or RU) for communicating with a terminal, at least a portion of the above-described radiators may be disposed outside the circuit board 305.

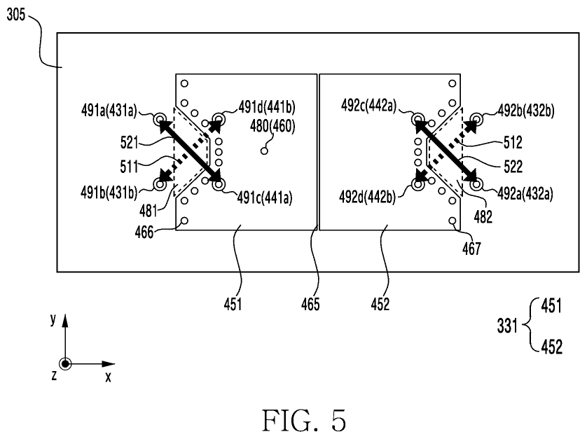

FIG. 5 is a diagram illustrating a polarization direction of a radiator array (e.g., a first radiator array 310, a second radiator array 320, or a third radiator array 330) in an antenna module (e.g., an antenna module 200) according to various embodiments. The same reference number may be used to indicate the same component and/or the same description.

Referring to FIG. 5, the antenna module 200 according to an embodiment may support double polarization. For example, the antenna module 200 may include the first radiator array 310, the second radiator array 320, and the third radiator array 330. An array antenna including the first radiator array 310 may support double polarization. Signals per polarization may be provided to each of patch radiators (e.g., a 1-1 patch radiator 311, a 1-2 patch radiator 312, a 1-3 patch radiator 313, a 1-4 patch radiator 314, or a 1-5 patch radiator 315) of the first radiator array 310. An array antenna including the second radiator array 320 may support double polarization. Signals per polarization may be provided to each of patch radiators (e.g., a 2-1 patch radiator 321, a 2-2 patch radiator 322, a 2-3 patch radiator 323, a 2-4 patch radiator 324, or a 2-5 patch radiator 325) of the second radiator array 320.

Each antenna in each frequency band (e.g., a first frequency band or a second frequency band) of FR2 (e.g., a frequency range of less than about 24.25 GHz) may have two feeding points. Signals of different polarizations may be provided at each feeding point. A frequency band (e.g., a third frequency band) of FR3 (e.g., a frequency range greater than or equal to about 7.125 GHz and less than about 24.25 GHz) may have one feeding point (e.g., a point 480 connected to a feeding portion 460). For a uniform characteristic of each antenna element in a radiator array, not only each patch radiator (e.g., a 3-1 patch radiator 331, or a 3-2 patch radiator 332) of the third radiator array 330 has a symmetrical shape, but also feeding portions for FR2 may be symmetrically disposed.

According to an embodiment, feeding portions that feed signals to two patch radiators (e.g., two patch radiators of the first radiator array 310 or two patch radiators of the second radiator array 320) disposed to overlap each patch radiator of the third radiator array 330 may also be symmetrically disposed. For example, the 3-1 patch radiator 331 of the third radiator array 330 may be disposed to overlap the 1-1 patch radiator 311 and the 1-2 patch radiator 312 of the first radiator array 310. When viewing the antenna module 200 in a direction (e.g., a (−) z-axis direction), a first feeding portion 431a for the first polarization 521 may be positioned at a point 491a for a 1-1 patch radiator 311, and a first feeding portion 432a for a first polarization 522 may be positioned at a point 492a for the 1-2 patch radiator 312. For example, a second feeding portion 431b for a second polarization 511 may be positioned at a point 491b for the 1-1 patch radiator 311, and a second feeding portion 432b for a second polarization 512 may be positioned at a point 492b for the 1-2 patch radiator 312. For example, the 3-1 patch radiator 331 of the third radiator array 330 may be disposed to overlap the 2-1 patch radiator 321 and the 2-2 patch radiator 322 of the second radiator array 320. When viewing the antenna module 200 in the direction (e.g., the (−) z-axis direction), a first feeding portion 441a for the first polarization 521 may be positioned at a point 491c for the 2-1 patch radiator 321, and a first feeding portion 442a for the first polarization 522 may be positioned at a point 492c for the 2-2 patch radiator 322. Conversely, a second feeding portion 441b for the second polarization 511 may be positioned at a point 491d for the 2-1 patch radiator 321, and a second feeding portion 442b for the second polarization 512 may be positioned at a point 492d for the 2-2 patch radiator 322.

According to an embodiment, when viewing the antenna module 200 in the direction (e.g., the (−) z-axis direction), positions of feeding portions (e.g., the first feeding portion 431a, the second feeding portion 431b, the first feeding portion 432a, or the second feeding portion 432b) for the first frequency band (e.g., a frequency band of FR2 greater than or equal to about 24.25 GHz, a band of about 26 GHz, or a band of about 28 GHz) may be disposed outside an area of the 3-1 patch radiator 331. When viewing the antenna module 200 in the direction (e.g., the (−) z-axis direction), positions of feeding portions (e.g., the first feeding portion 441a, the second feeding portion 441b, the first feeding portion 442a, or the second feeding portion 442b) for the second frequency band (e.g., a frequency band of FR2 of greater than or equal to about 24.25 GHz or a band of about 39 GHz) may be disposed within the area of the 3-1 patch radiator 331.

According to an embodiment, when viewing the antenna module 200 in the direction (e.g., the (−) z-axis direction), the positions of the feeding portions (e.g., the first feeding portion 431a, the second feeding portion 431b, the first feeding portion 432a, or the second feeding portion 432b) for the first frequency band (e.g., the frequency band of FR2 greater than or equal to about 24.25 GHz, the band of about 26 GHz, or the band of about 28 GHz) may be disposed within the area of the 3-1 patch radiator 331. When viewing the antenna module 200 in the direction (e.g., the (−) z-axis direction), the positions of the feeding portions (e.g., the first feeding portion 441a, the second feeding portion 441b, the first feeding portion 442a, or the second feeding portion 442b) for the second frequency band (e.g., the frequency band of FR2 of greater than or equal to about 24.25 GHz or the band of about 39 GHz) may be disposed outside the area of the 3-1 patch radiator 331. As an example, the first feeding portion 431a for the first polarization of the first frequency band may be positioned at the point 491d, and the second feeding portion 431b for the second polarization of the first frequency band may be positioned at the point 491c. The first feeding portion 432a for the first polarization of the first frequency band may be positioned at the point 492d, and the second feeding portion 432b for the second polarization of the first frequency band may be positioned at the point 492c. As an example, the first feeding portion 441a for the first polarization of the second frequency band may be positioned at the point 491b, and the second feeding portion 441b for the second polarization of the second frequency band may be positioned at the point 491a. The first feeding portion 442a for the first polarization of the second frequency band may be positioned at the point 492b, and the second feeding portion 442b for the second polarization of the second frequency band may be positioned at the point 492a.

When disposing the patch radiators (e.g., the 1-1 patch radiator 311, the 1-2 patch radiator 312, the 1-3 patch radiator 313, the 1-4 patch radiator 314, or the 1-5th patch radiator 315) of the first radiator array 310, as the patch radiators are symmetrical with respect to the patch radiators (e.g., the 3-1 patch radiator 331 or the 3-2 patch radiator 332) of the third radiator array 330, an influence of the third radiator array 330 on the first radiator array 310 may be reduced. For example, when disposing the patch radiators (e.g., the 2-1 patch radiator 321, the 2-2 patch radiator 322, the 2-3 patch radiator 323, the 2-4 patch radiator 324, or the 2-5 patch radiator 325) of the second radiator array 320, as the patch radiators are symmetrical with respect to the patch radiators (e.g., the 3-1 patch radiator 331 or the 3-2 patch radiator 332) of the third radiator array 330, an influence of the third radiator array 330 on the second radiator array 320 may be reduced.

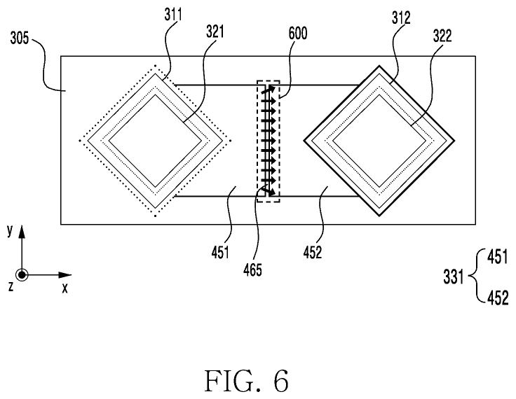

FIG. 6 is a diagram illustrating an electric field of patch portions of a radiator array in an antenna module (e.g., an antenna module 200) according to various embodiments. The same reference number may be used to indicate the same component and/or the same description.

Referring to FIG. 6, an electronic device 101 may include the antenna module 200. The antenna module 200 may include a circuit board 305. The circuit board 305 may include a plurality of layers. A patch radiator may be formed on at least a portion of the plurality of layers. For example, the circuit board 305 may include a first radiator array 310, a second radiator array 320, and a third radiator array 330. The first radiator array 310 may include patch radiators (e.g., a 1-1 patch radiator 311 or a 1-2 patch radiator 312). The second radiator array 320 may include patch radiators (e.g., a 2-1 patch radiator 321 or a 2-2 patch radiator 322). The third radiator array 330 may include patch radiators (e.g., a 3-1 patch radiator 331 or a 3-2 patch radiator 332).

As an example, the 3-1 patch radiator 331 may include a first patch portion 451 and a second patch portion 452. A gap 465 may be formed between the first patch portion 451 and the second patch portion 452. At least a portion of signals radiated through the first patch portion 451 may be provided to the second patch portion 452 through coupling. The second patch portion 452, which is a parasitic patch, may be configured to radiate signals of a third frequency band. While the first patch portion 451 and the second patch portion 452 respectively radiate signals, the signals may be concentrated in an area 600 (e.g., an area adjacent to the gap 465 among the first patch portion 451, and an area adjacent to the gap 465 among the second patch portion 452) adjacent to the gap 465. The area 600 may be disposed in a space between the 1-1 patch radiator 311 and the 1-2 patch radiator 312. The area 600 may be disposed in a space between the 2-1 patch radiator 321 and the 2-2 patch radiator 322. As a structure is not positioned in a direction (e.g., a (+) z-axis direction) in the area 600 where the signals of the third frequency band (e.g., a frequency band of FR3 greater than or equal to about 7.125 GHz and less than about 24.25 GHz, a band of about 12 GHz, or a band of about 15 GHz) are concentrated, radiation performance (e.g., radiation efficiency) of the 1-1 patch radiator 311 may be improved. In addition, an influence on the 1-1 patch radiator 311 and the 1-2 patch radiator 312 may be reduced due to radiation of the 3-1 patch radiator 331. Likewise, an influence on the 2-1 patch radiator 321 and the 2-2 patch radiator 322 may be reduced due to the radiation of the 3-1 patch radiator 331.

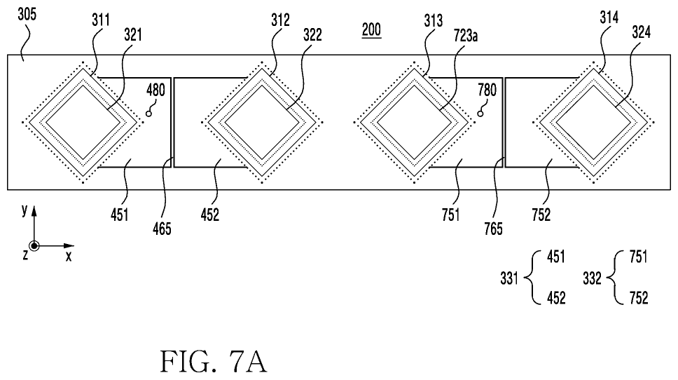

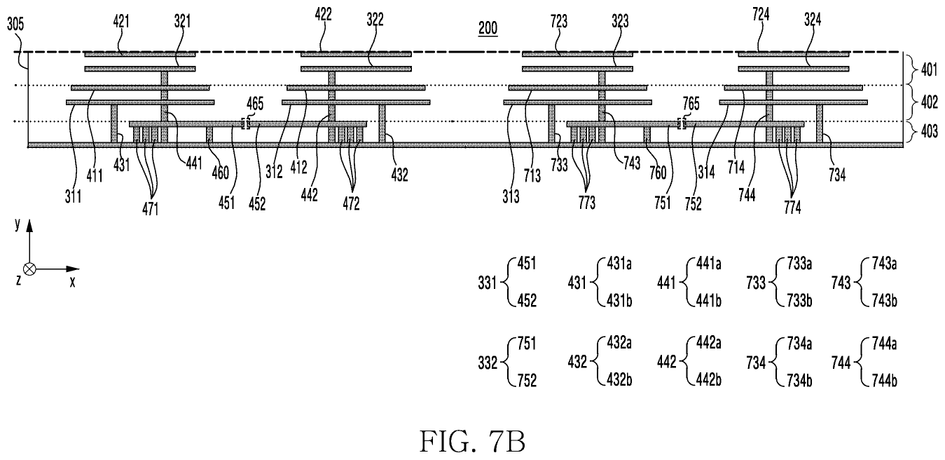

FIGS. 7A and 7B are diagrams illustrating an example of an antenna module (e.g., an antenna module 200) including radiator arrays (e.g., a first radiator array 310, a second radiator array 320, or a third radiator array 330) according to various embodiments. In FIGS. 7A and 7B, the antenna module 200 including a radiator array having a 1×4 disposition is described as an example. FIG. 7A is a diagram in which the antenna module 200 is viewed in a direction (e.g., a (−) z-axis direction), and FIG. 7B is a diagram in which the antenna module 200 is viewed in another direction (e.g., a (+) y-axis direction). The same reference number may be used to indicate the same component and/or the same description.

Referring to FIGS. 7A and 7B, an electronic device 101 may include the antenna module 200. The antenna module 200 may include a circuit board 305. The circuit board 305 may include a plurality of layers. A patch radiator may be formed on at least a portion of the plurality of layers. For example, the circuit board 305 may include the first radiator array 310 for a first frequency band (e.g., a frequency band of FR2 greater than or equal to about 24.25 GHz, a band of about 26 GHz, or a band of about 28 GHz), the second radiator array 320 for a second frequency band (e.g., a frequency band of FR2 greater than or equal to about 24.25 GHz, or a band of about 39 GHz), and the third radiator array 330 for a third frequency band (e.g., a frequency band of FR3 greater than or equal to about 7.125 GHz and less than about 24.25 GHz, a band of about 12 GHz, or a band of about 15 GHz). For example, the first radiator array 310 may include a 1-1 patch radiator 311, a 1-2 patch radiator 312, a 1-3 patch radiator 313, and a 1-4 patch radiator 314. The second radiator array 320 may include a 2-1 patch radiator 321, a 2-2 patch radiator 322, a 2-3 patch radiator 323, and a 2-4 patch radiator 324. The third radiator array 330 may include a 3-1 patch radiator 331 and a 3-2 patch radiator 332.

The 1-1 patch radiator 311 of the first radiator array 310 may be connected to a feeding portion 431. The feeding portion 431 may include a conductive structure (e.g., a via, or a line) for transmitting RF signals processed through RF processing circuitry to a patch radiator. As an example, an antenna including the 1-1 patch radiator 311 may support double polarization. For example, the feeding portion 431 may include a first feeding portion 431a for a first polarization and a second feeding portion 431b for a second polarization. The 1-2 patch radiator 312 may be connected to a feeding portion 432. For example, the feeding portion 432 may include a first feeding portion 432a for the first polarization and a second feeding portion 432b for the second polarization. The 1-3 patch radiator 313 may be connected to a feeding portion 733. For example, the 4 portion 733 may include a first 4 portion 733a for the first polarization and a second feeding portion 733b for the second polarization. The 1-4 patch radiator 314 may be connected to a feeding portion 734. For example, the feeding portion 734 may include a first feeding portion 734a for the first polarization and a second feeding portion 734b for the second polarization.

The 2-1 patch radiator 321 of the second radiator array 320 may be connected to a feeding portion 441. The feeding portion 441 may include a conductive structure (e.g., a via, or a line) for transmitting RF signals processed through RF processing circuitry to a patch radiator. As an example, an antenna including the 2-1 patch radiator 321 may support double polarization. For example, the feeding portion 441 may include a first feeding portion 441a for a first polarization and a second feeding portion 441b for a second polarization. The 2-2 patch radiator 322 may be connected to a feeding portion 442. For example, the feeding portion 442 may include a first feeding portion 442a for the first polarization and a second feeding portion 442b for the second polarization. The 2-3 patch radiator 323 may be connected to a feeding portion 743. For example, the feeding portion 743 may include a first feeding portion 743a for the first polarization and a second feeding portion 743b for the second polarization. The 2-4th patch radiator 324 may be connected to a feeding portion 744. For example, the feeding portion 744 may include a first feeding portion 744a for the first polarization and a second feeding portion 744b for the second polarization.

According to an embodiment, in order to increase a bandwidth or a radiation gain through coupling, the circuit board 305 may further include a patch radiator connected to a feeding portion and a parasitic patch radiator disposed to overlap the patch radiator. The parasitic patch radiator may be disposed on a layer different from the layer on which the patch radiator is disposed. For example, a 1-1 additional patch radiator 411 may be disposed on a layer at a higher position (e.g., a position with a larger coordinate on a z-axis or a (+) z-axis direction) than a first layer where the 1-1 patch radiator 311 is disposed. The 1-1 additional patch radiator 411 may be configured to radiate signals through coupling with the 1-1 patch radiator 311. A 2-1 additional patch radiator 412 may be disposed on a layer at a higher position (e.g., a position with a larger coordinate on the z-axis or the (+) z-axis direction) than the first layer where the 1-2 patch radiator 312 is disposed. The 2-1 additional patch radiator 412 may be configured to radiate signals through coupling with the 1-2 patch radiator 312. A 3-1 additional patch radiator 713 may be disposed on a layer at a higher position (e.g., a position with a larger coordinate on the z-axis or the (+) z-axis direction) than the first layer where the 1-3 patch radiator 313 is disposed. The 3-1 additional patch radiator 713 may be configured to radiate signals through coupling with the 1-3 patch radiator 313. A 4-1 additional patch radiator 714 may be disposed on a layer at a higher position (e.g., a position with a larger coordinate on the z-axis or the (+) z-axis direction) than the first layer where the 1-4 patch radiator 314 is disposed. The 4-1 additional patch radiator 714 may be configured to radiate signals through coupling with the 1-4 patch radiator 314. In addition, for example, a 1-2 additional patch radiator 421 may be disposed on a layer at a higher position (e.g., a position with a larger coordinate on the z-axis or the (+) z-axis direction) than a second layer where the 2-1 patch radiator 321 is disposed. The 1-2 additional patch radiator 421 may be configured to radiate signals through coupling with the 2-1 patch radiator 321. A 2-2 additional patch radiator 422 may be disposed on a layer at a higher position (e.g., a position with a larger coordinate on the z-axis or the (+) z-axis direction) than the second layer where the 2-2 patch radiator 322 is disposed. The 2-2 additional patch radiator 422 may be configured to radiate signals through coupling with the 2-2 patch radiator 322. A 3-2 additional patch radiator 723 may be disposed on a layer at a higher position (e.g., a position with a larger coordinate on the z-axis or the (+) z-axis direction) than the second layer where the 2-3 patch radiator 323 is disposed. The 3-2 additional patch radiator 723 may be configured to radiate signals through coupling with the 2-3 patch radiator 323. A 4-2 additional patch radiator 724 may be disposed on a layer at a higher position (e.g., a position with a larger coordinate on the z-axis or the (+) z-axis direction) than the second layer where the 2-4 patch radiator 324 is disposed. The 4-2 additional patch radiator 724 may be configured to radiate signals through coupling with the 2-4 patch radiator 324.

According to an embodiment, the 3-2 patch radiator 332 may be disposed to overlap two adjacent radiation patches (e.g., the 1-3 patch radiator 313 and the 1-4 patch radiator 314) of the first radiator array 310. The 3-2 patch radiator 332 may be disposed to overlap two adjacent radiation patches (e.g., the 2-3 patch radiator 323 and the 2-4 patch radiator 324) of the second radiator array 320. The 3-2 patch radiator 332 may include two patch portions (e.g., a first patch portion 751 or a second patch portion 752) in substantially the same manner as the 3-1 patch radiator 331. A gap 765 may be formed between the first patch portion 751 and the second patch portion 752. The gap 765 may be positioned in a space between the 1-3 patch radiator 313 and the 1-4 patch radiator 314. The gap 765 may be positioned in a space between the 2-3 patch radiator 323 and the 2-4 patch radiator 324. The 3-2 patch radiator 332 may be connected to a feeding portion 760 at a point 780. The feeding portion 760 may include a conductive structure (e.g., a via, or a line) for transmitting RF signals processed through RF processing circuitry to the 2-2 patch radiator 332. The 3-2 patch radiator 332 may be connected to conductive vias connected to a ground. For example, the conductive vias may include a third set of conductive vias 773 and a fourth set of conductive vias 774. The 3-2 patch radiator 332 may include the first patch portion 751 and the second patch portion 752 that are distinguished with respect to an axis (e.g., a y-axis). For example, the third set of conductive vias 773 may be used to connect the first patch portion 751 to the ground (e.g., a ground layer of the circuit board 305). For example, the fourth set of conductive vias 774 may be used to connect the second patch portion 752 to the ground (e.g., the ground layer of the circuit board 305).

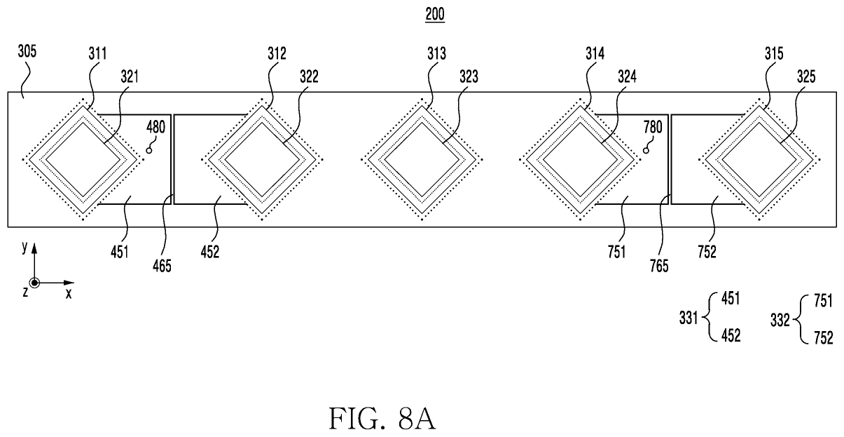

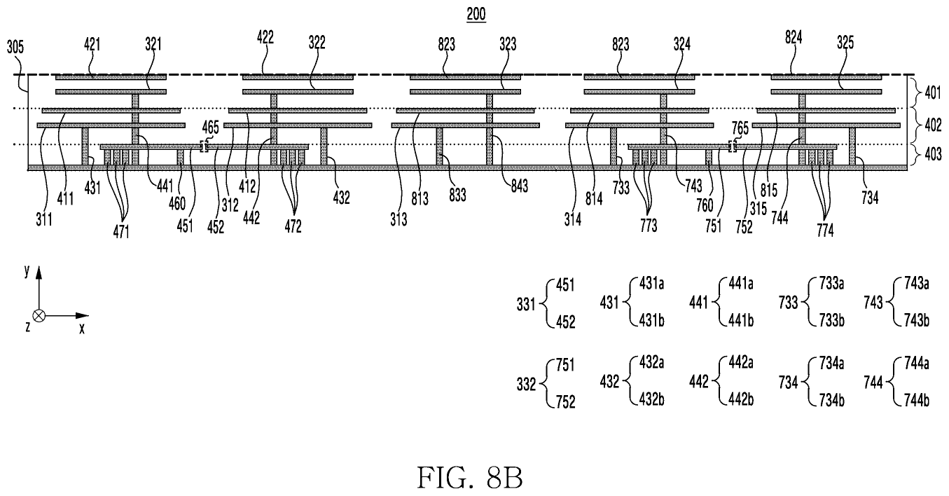

FIGS. 8A and 8B are diagrams illustrating an example of an antenna module (e.g., an antenna module 200) including radiator arrays (e.g., a first radiator array 310, a second radiator array 320, or a third radiator array 330) according to various embodiments. In FIGS. 8A and 8B, an antenna module including a radiator array having a 1×5 disposition is described as an example. FIG. 8A is a diagram in which the antenna module 200 is viewed in a direction (e.g., a (−) z-axis direction), and FIG. 8B is a diagram in which the antenna module 200 is viewed in another direction (e.g., a (+) y-axis direction). The same reference number may be used to indicate the same component and/or the same description.

Referring to FIGS. 8A and 8B, an electronic device 101 may include the antenna module 200. The antenna module 200 may include a circuit board 305. The circuit board 305 may include a plurality of layers. A patch radiator may be formed on at least a portion of the plurality of layers. For example, the circuit board 305 may include the first radiator array 310 for a first frequency band (e.g., a frequency band of FR2 greater than or equal to about 24.25 GHz, a band of about 26 GHz, or a band of about 28 GHz), the second radiator array 320 for a second frequency band (e.g., a frequency band of FR2 greater than or equal to about 24.25 GHz, or a band of about 39 GHz), and the third radiator array 330 for a third frequency band (e.g., a frequency band of FR3 greater than or equal to about 7.125 GHz and less than about 24.25 GHz, a band of about 12 GHz, or a band of about 15 GHz). For example, the first radiator array 310 may include a 1-1 patch radiator 311, a 1-2 patch radiator 312, a 1-3 patch radiator 313, a 1-4 patch radiator 314, and a 1-5 patch radiator 315. The second radiator array 320 may include a 2-1 patch radiator 321, a 2-2 patch radiator 322, a 2-3 patch radiator 323, a 2-4 patch radiator 324, and a 2-5 patch radiator 325. The third radiator array 330 may include a 3-1 patch radiator 331 and a 3-2 patch radiator 332.

The 1-1 patch radiator 311 of the first radiator array 310 may be connected to a feeding portion 431. An antenna including the 1-1 patch radiator 311 may support double polarization. The feeding portion 431 may include a first feeding portion 431a for a first polarization and a second feeding portion 431b for a second polarization. The 1-2 patch radiator 312 may be connected to a feeding portion 432. The feeding portion 432 may include a first feeding portion 432a for the first polarization and a second feeding portion 432b for the second polarization. The 1-3 patch radiator 313 may be connected to a feeding portion 833. The feeding portion 833 may include a first feeding portion 833a for the first polarization and a second feeding portion 833b for the second polarization. The 1-4 patch radiator 314 may be connected to a feeding portion 733. The feeding portion 733 may include a first feeding portion 733a for the first polarization and a second feeding portion 733b for the second polarization. The 1-5 patch radiator 315 may be connected to a feeding portion 734. The feeding portion 734 may include a first feeding portion 734a for the first polarization and a second feeding portion 734b for the second polarization.

The 2-1 patch radiator 321 of the second radiator array 320 may be connected to a feeding portion 441. The feeding portion 441 may include a conductive structure (e.g., a via, or a line) for transmitting RF signals processed through RF processing circuitry to a patch radiator. An antenna including the 2-1 patch radiator 321 may support double polarization. The feeding portion 441 may include a first feeding portion 441a for the first polarization and a second feeding portion 441b for the second polarization. The 2-2 patch radiator 322 may be connected to a feeding portion 442. The feeding portion 442 may include a first feeding portion 442a for the first polarization and a second feeding portion 442b for the second polarization. The 2-3 patch radiator 323 may be connected to a feeding portion 843. The feeding portion 843 may include a first feeding portion 843a for the first polarization and a second feeding portion 843b for the second polarization. The 2-4 patch radiator 324 may be connected to a feeding portion 743. The feeding portion 743 may include a first feeding portion 743a for the first polarization and a second feeding portion 743b for the second polarization. The 2-5 patch radiator 325 may be connected to a feeding portion 744. The feeding portion 744 may include a first feeding portion 744a for the first polarization and a second feeding portion 744b for the second polarization.

According to an embodiment, in order to increase a bandwidth or a radiation gain through coupling, the circuit board 305 may further include a patch radiator connected to a feeding portion and a parasitic patch radiator disposed to overlap the patch radiator. The parasitic patch radiator may be disposed on a layer different from the layer on which the patch radiator is disposed. For example, a 1-1 additional patch radiator 411 may be disposed on a layer at a higher position (e.g., a position with a larger coordinate on a z-axis or a (+) z-axis direction) than a first layer where the 1-1 patch radiator 311 is disposed. The 1-1 additional patch radiator 411 may be configured to radiate signals through coupling with the 1-1 patch radiator 311. A 2-1 additional patch radiator 412 may be disposed on a layer at a higher position (e.g., a position with a larger coordinate on the z-axis or the (+) z-axis direction) than the first layer where the 1-2 patch radiator 312 is disposed. The 2-1 additional patch radiator 412 may be configured to radiate signals through coupling with the 1-2 patch radiator 312. A 3-1 additional patch radiator 813 may be disposed on a layer at a higher position (e.g., a position with a larger coordinate on the z-axis or the (+) z-axis direction) than the first layer in which the 1-3 patch radiator 313 is disposed. The 3-1 additional patch radiator 813 may be configured to radiate signals through coupling with the 1-3 patch radiator 313. A 4-1 additional patch radiator 814 may be disposed on a layer at a higher position (e.g., a position with a larger coordinate on the z-axis or the (+) z-axis direction) than the first layer where the 1-4 patch radiator 314 is disposed. The 4-1 additional patch radiator 814 may be configured to radiate signals through coupling with the 1-4 patch radiator 314. A 5-1 additional patch radiator 815 may be disposed on a layer at a higher position (e.g., a position with a larger coordinate on the z-axis or the (+) z-axis direction) than the first layer where the 1-5 patch radiator 315 is disposed. The 5-1 additional patch radiator 815 may be configured to radiate signals through coupling with the 1-5 patch radiator 315.

For example, a 1-2 additional patch radiator 421 may be disposed on a layer at a higher position (e.g., a position with a larger coordinate on the z-axis or the (+) z-axis direction) than a second layer where the 2-1 patch radiator 321 is disposed. The 1-2 additional patch radiator 421 may be configured to radiate signals through coupling with the 2-1 patch radiator 321. A 2-2 additional patch radiator 422 may be disposed on a layer at a higher position (e.g., a position with a larger coordinate on the z-axis or the (+) z-axis direction) than the second layer where the 2-2 patch radiator 322 is disposed. The 2-2 additional patch radiator 422 may be configured to radiate signals through coupling with the 2-2 patch radiator 322. A 3-2 additional patch radiator 823 may be disposed on a layer at a higher position (e.g., a position with a larger coordinate on the z-axis or the (+) z-axis direction) than the second layer where the 2-3 patch radiator 323 is disposed. The 3-2 additional patch radiator 823 may be configured to radiate signals through coupling with the 2-3 patch radiator 323. A 4-2 patch radiator 824 may be disposed on a layer at a higher position (e.g., a position with a larger coordinate on the z-axis or the (+) z-axis direction) than the second layer where the 2-4 patch radiator 324 is disposed. The 4-2 patch radiator 824 may be configured to radiate signals through coupling with the 2-4 patch radiator 324. A 5-2 patch radiator 825 may be disposed on a layer at a higher position (e.g., a position with a larger coordinate on the z-axis) than the second layer where the 2-5 patch radiator 325 is disposed. The 5-2 patch radiator 825 may be configured to radiate signals through coupling with the 2-5 patch radiator 325.

According to an embodiment, the 3-2 patch radiator 332 may be disposed to overlap two adjacent radiation patches (e.g., the 1-4 patch radiator 314 and the 1-5 patch radiator 315) of the first radiator array 310. The 3-2 patch radiator 332 may be disposed to overlap two adjacent radiation patches (e.g., the 2-4 patch radiator 324 and the 2-5 patch radiator 325) of the second radiator array 320. The 3-2 patch radiator 332 may include two patch portions (e.g., a first patch portion 751 or a second patch portion 752) in substantially the same manner as the 3-1 patch radiator 331. A gap 765 may be formed between the first patch portion 751 and the second patch portion 752. The gap 765 may be positioned in a space between the 1-4 patch radiator 314 and the 1-5 patch radiator 315. The gap 765 may be positioned in a space between the 2-4 patch radiator 324 and the 2-5 patch radiator 325. The 3-2 patch radiator 332 may be connected to a feeding portion 760 at a point 780. The feeding portion 760 may include a conductive structure (e.g., a via, or line) for transmitting RF signals processed through RF processing circuitry to a patch radiator. The 3-2 patch radiator 332 may be connected to conductive vias connected to a ground. For example, the conductive vias may include a third set of conductive vias 773 and a fourth set of conductive vias 774. The 3-2 patch radiator 332 may include the first patch portion 751 and the second patch portion 752 that are distinguished with respect to an axis (e.g., a y axis). For example, the third set of conductive vias 773 may be used to connect the first patch portion 751 to the ground (e.g., a ground layer of the circuit board 305). For example, the fourth set of conductive vias 774 may be used to connect the second patch portion 752 to the ground (e.g., the ground layer of the circuit board 305).

In FIGS. 8A and 8B, a structure in which the 3-1 patch radiator 331 of the third radiator array 330 is disposed between the 1-1 patch radiator 311 and the 1-2 patch radiator 312 of the first radiator array 310 and the 3-2 patch radiator 332 of the third radiator array 330 is disposed between the 1-4 patch radiator 314 and the 1-5 patch radiator 315 of the first radiator array 310 has been illustrated, but the present disclosure is not limited thereto. According to an embodiment, the antenna module 200 may have a structure in which the 3-1 patch radiator 331 of the third radiator array 330 is disposed between the 1-1 patch radiator 311 and the 1-2 patch radiator 312 of the first radiator array 310 and the 3-2 patch radiator 332 of the third radiator array 330 is disposed between the 1-3 patch radiator 313 and the 1-4 patch radiator 314 of the first radiator array 310.

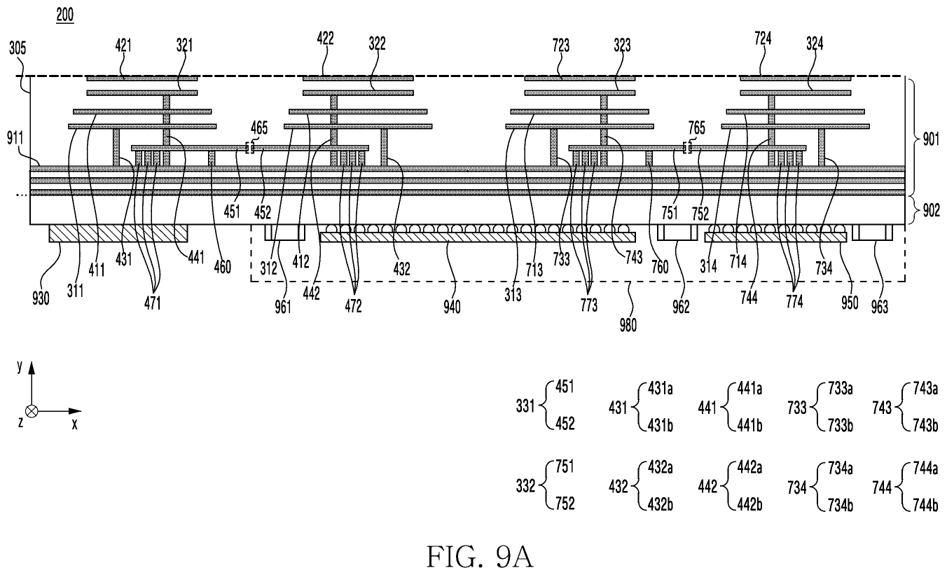

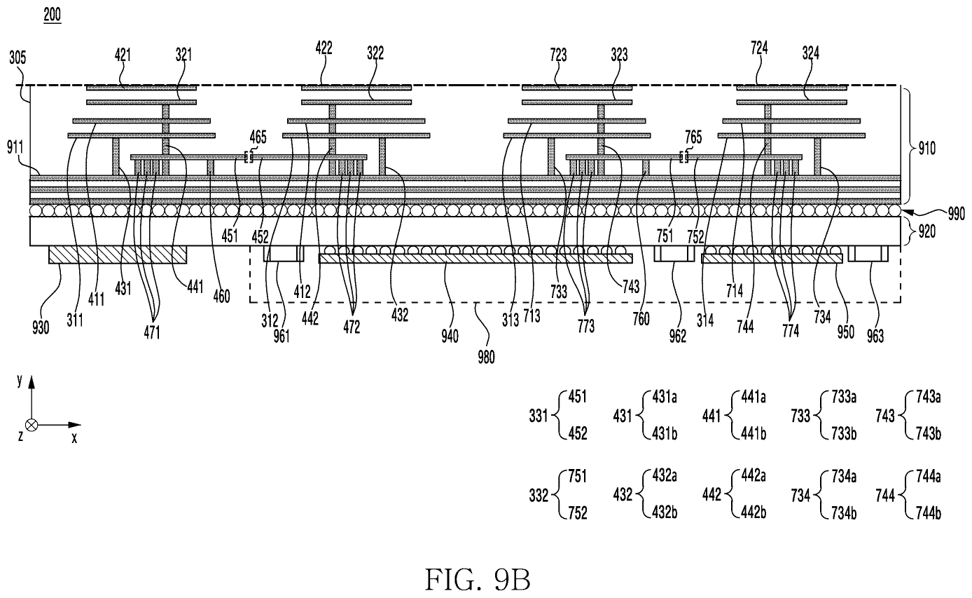

FIGS. 9A and 9B are cross-sectional views illustrating an example of an antenna module (e.g., an antenna module 200) including radio frequency (RF) processing circuitry and radiator arrays (e.g., a first radiator array 310, a second radiator array 320, or a third radiator array 330) according to various embodiments. In FIGS. 9A and 9B, the antenna module 200 including a radiator array having a 1×4 disposition illustrated in FIG. 7 is described as an example. The same reference number may be used to indicate the same component and/or the same description.

Referring to FIG. 9A, an electronic device 101 may include the antenna module 200. The antenna module 200 may include a circuit board 305. The circuit board 305 may include a plurality of layers. The plurality of layers may include a first set of layers 901 and a second set of layers 902. The first set of layers 901 may include patch radiators. At least a portion of a conductive portion (e.g., metal) formed in the first set of layers 901 may be used as a patch radiator. For example, the circuit board 305 may include the first radiator array 310 for a first frequency band (e.g., a frequency band of FR2 greater than or equal to about 24.25 GHz, a band of about 26 GHz, or a band of about 28 GHz), the second radiator array 320 for a second frequency band (e.g., a frequency band of FR2 greater than or equal to about 24.25 GHz, or a band of about 39 GHz), and the third radiator array 330 for a third frequency band (e.g., a frequency band of FR3 greater than or equal to about 7.125 GHz and less than about 24.25 GHz, a band of about 12 GHz, or a band of about 15 GHz). For example, the first radiator array 310 may include a 1-1 patch radiator 311, a 1-2 patch radiator 312, a 1-3 patch radiator 313, and a 1-4 patch radiator 314. The second radiator array 320 may include a 2-1 patch radiator 321, a 2-2 patch radiator 322, a 2-3 patch radiator 323, and a 2-4 patch radiator 324. The third radiator array 330 may include a 3-1 patch radiator 331 and a 3-2 patch radiator 332. The second set of layers 902 may include a circuit wiring for connecting a plurality of components and a radiator. For example, the circuit board 305 may include a feeding via formed to penetrate the layers of the second set of layers 902 or a feeding line formed on a layer to feed a signal to a patch radiator.

According to an embodiment, the antenna module 200 may include a plurality of components for processing RF signals. For example, the antenna module 200 may include a connector 930, RF processing circuitry 940 (e.g., RFIC), and/or power management circuitry 950 (e.g., the power management module 188 of FIG. 1, PMIC). The connector 930, the RF processing circuitry 940, and the power management circuitry 950 may be disposed above a side (e.g., a side facing a (−) z-axis) of the circuit board 305. The connector 930 may be electrically connected to a printed circuit board (e.g., the printed circuit board 210 of FIG. 2) of the electronic device 101 through FPCB (e.g., the flexible printed circuit board 204 of FIG. 2). The antenna module 200 may be electrically connected to at least one component (e.g., a processor 120, a communication module 192, or an intermediate frequency integrated circuit (IFIC)) of the printed circuit board 210 through the connector 930. The RF processing circuitry 940 may be implemented as a single chip (e.g., an RFIC chip) or as a portion of a single package. The RF processing circuit 940 may include a mixer and an oscillator (e.g., a local oscillator (LO)) for up-conversion. The RF processing circuit 940 may include a mixer and an oscillator for down-conversion. According to an embodiment, the RF processing circuitry 940 may be used to process signals in the first frequency band (e.g., the frequency band of FR2 greater than or equal to about 24.25 GHz, the band of about 26 GHz, or the band of about 28 GHz). According to an embodiment, the RF processing circuitry 940 may be used to process signals in the second frequency band (e.g., the frequency band of FR2 greater than or equal to about 24.25 GHz, or the band of about 39 GHz). The power management circuitry 950 may be configured to receive power from a battery (e.g., the battery 189 of FIG. 1) of the electronic device 101 and supply a stable voltage to the RF processing circuitry 940 based on the power. In addition, for example, the antenna module 200 may include at least one element (e.g., a passive element, an inductor, a capacitor, or a resistor). The at least one element may be used for decoupling, noise removal, and/or impedance matching. For example, a first element 961, a second element 962, and/or a third element 963 may be disposed on a side (e.g., a side facing the (−) z-axis) of the circuit board 305. As a non-limiting example, a molding member 980 may be disposed on the side (e.g., the side facing the (−) z axis) of the circuit board 305 for protection of at least a portion (e.g., the RF processing circuitry 940, and the power management circuitry 950, the first element 961, the second element 962, and/or the third element 963) of the plurality of components.

Referring to FIG. 9B, the electronic device 101 may include the antenna module 200. The antenna module 200 may include a first board 910 (e.g., PCB) and a second board 920 (e.g., PCB). The first board 910 and the second board 920 may be coupled according to a surface mount technology (SMT) method. As a non-limiting example, a ball grid array (BGA) 990 may be disposed between the first board 910 and the second board 920. The first board 910 and the second board 920 may be coupled through the BGA 990. The first board 910 may include a plurality of layers. The plurality of layers of the first board 910 may include patch radiators. At least a portion of a conductive portion (e.g., metal) formed in the plurality of layers may be used as a patch radiator. For example, the first board 910 may include the first radiator array 310 for the first frequency band (e.g., the frequency band of FR2 greater than or equal to about 24.25 GHz, the band of about 26 GHz, or the band of about 28 GHz), the second radiator array 320 for the second frequency band (e.g., the frequency band of FR2 greater than or equal to about 24.25 GHz, or the band of about 39 GHz), and the third radiator array 330 for the third frequency band (e.g., the frequency band of FR3 greater than or equal to about 7.125 GHz and less than about 24.25 GHz, the band of about 12 GHz, or the band of about 15 GHz). For example, the first radiator array 310 may include a 1-1 patch radiator 311, a 1-2 patch radiator 312, a 1-3 patch radiator 313, and a 1-4 patch radiator 314. The second radiator array 320 may include a 2-1 patch radiator 321, a 2-2 patch radiator 322, a 2-3 patch radiator 323, and a 2-4 patch radiator 324. The third radiator array 330 may include a 3-1 patch radiator 331 and a 3-2 patch radiator 332. The second board 920 may include a circuit wiring for connecting a plurality of components and a radiator. For example, the second board 920 may include a feeding via formed to penetrate layers or a feeding line formed on a layer to feed a signal to a patch radiator.

According to an embodiment, the antenna module 200 may include a plurality of components for processing RF signals. For example, the antenna module 200 may include a connector 930, RF processing circuitry 940 (e.g., RFIC), and/or power management circuitry 950 (e.g., the power management module 188 of FIG. 1). For the connector 930, the RF processing circuitry 940, and the power management circuitry 950, the descriptions of FIG. 9A may be referenced. The connector 930, the RF processing circuitry 940, and the power management circuitry 950 may be disposed above a side (e.g., a side facing the (−) z axis) of the second board 920. In addition, for example, the antenna module 200 may include at least one element (e.g., the first element 961, the second element 962, and/or the third element 963) for matching. The first element 961, the second element 962, and the third element 963 may be disposed on the side (e.g., the side facing the (−) z axis) of the second board 920. As a non-limiting example, for protecting at least a portion (e.g., the RF processing circuitry 940, and the power management circuitry 950, the first element 961, the second element 962, and/or the third element 963) of the plurality of components, a molding member 980 may be disposed on the side (e.g., the side facing the (−) z axis) of the second board 920.

The antenna module (e.g., the antenna module 200) according to embodiments of the present disclosure may have a structure for efficiently disposing radiator arrays supporting different frequency bands within a limited space. The radiator disposition described through FIGS. 3 to 9B may be used to secure constant radiation performance while the disposition of radiators in a radiator array for a specific frequency band less affects radiation performance of a radiator array for another frequency band. Since a lower frequency band requires longer spacing between the radiators and a larger radiator area size, each radiator for the third frequency band (e.g., the frequency band of FR3 greater than or equal to about 7.125 GHz and less than about 24.25 GHz, the band of about 12 GHz, or the band of about 15 GHz) may be disposed between radiators for another frequency band (e.g., the first frequency band (e.g., the frequency band of FR2 greater than or equal to about 24.25 GHz, the band of about 26 GHz, or the band of about 28 GHz), or the second frequency band (e.g., the frequency band of FR2 greater than or equal to about 24.25 GHz, or the band of about 39 GHz)). Additionally, the radiators for the third frequency band may be disposed at a lower height than the radiators for other frequency bands in order to radiate signals through an area between the radiators without blocking the radiators.

In FIGS. 9A and 9B, radiators formed on layers of a circuit board (e.g., the circuit board 305) have been described as an example, but the present disclosure is not limited thereto. According to an embodiment, radiators of radiator arrays (e.g., the first radiator array 310, the second radiator array 320, or the third radiator array 330) may be disposed by being spaced apart from a side of the circuit board 305 by predetermined spacing. For example, radiators of the first radiator array 310 may be disposed by being spaced apart from the side of the circuit board 305 by a first length. Radiators of the second radiator array 320 may be disposed by being spaced apart from the surface of the circuit board 305 by a second length. The second length may be longer than the first length. A feeding portion connected to each radiator may include a separate feeding structure (e.g., a feeding bridge) disposed on the side of the circuit board 305 instead of a via in the circuit board 305. Radiators of the third radiator array 330 may be disposed by being spaced apart from the surface of the circuit board 305 by a third length. The third length may be shorter than the first length. The radiators of the third radiator array 330 may be disposed to have a lower height than the radiators of the second radiator array 320. In addition, each of the radiators (e.g., the 3-1 patch radiator 331, or the 3-2 patch radiator 332) of the third radiator array 330 may be disposed to overlap between radiators of another radiator array. As a non-limiting example, an individual radiator and a feeding portion in a radiator array may correspond to an integrally formed metal structure.

According to an embodiment, at least a portion of radiators of radiator arrays (e.g., the first radiator array 310, the second radiator array 320, or the third radiator array 330) may be disposed above the circuit board 305 through a feeding member separate from the circuit board 305 rather than a layer in the circuit board 305. As a non-limiting example, the radiators of the first radiator array 310 (e.g., the 1-1 patch radiator 311, the 1-2 patch radiator 312, a 1-1 additional patch radiator 411, a 2-1 additional patch radiator 412, the 1-3 patch radiator 313, a 3-1 additional patch radiator 713, the 1-4 patch radiator 314, or the 4-1 additional patch radiator 714) and the radiators (e.g., the 3-1 patch radiator 331, or the 3-2 patch radiator 332) of the third radiator array 330 may be disposed on layers in the circuit board 305, and the radiators (e.g., the 2-1 patch radiator 321, the 2-2 patch radiator 322, the 2-3 patch radiator 323, the 2-4 patch radiator 324, a 1-2 additional patch radiator 421, a 2-3 additional patch radiator 422, a 3-2 additional patch radiator 723, and/or a 4-2 additional patch radiator 724) of the second radiator array 320 may be disposed outside the circuit board 305. Each of the radiators of the second radiator array 320 may be connected to a separate feeding structure disposed on the circuit board 305. As a non-limiting example, the radiators (e.g., the 3-1 patch radiator 331 or the 3-2 patch radiator 332) of the third radiator array 330 may be disposed on the layers in the circuit board 305, and the radiators (e.g., the 1-1 patch radiator 311, the 1-2 patch radiator 312, the 1-1 additional patch radiator 411, the 2-1 additional patch radiator 412, the 1-3 patch radiator 313, the 3-1 additional patch radiator 713, the 1-4 patch radiator 314, or the 4-1 additional patch radiator 714) of the first radiator array 310 and the radiators (e.g., the 2-1 patch radiator 321, the 2-2 patch radiator 322, the 2-3 patch radiator 323, the 2-4 patch radiator 324, the 1-2 additional patch radiator 421, the 2-2 additional patch radiator 422, the 3-2 additional patch radiator 723, and/or the 4-2 additional patch radiator 724) of the second radiator array 320 may be disposed outside the circuit board 305. Each of the radiators of the first radiator array 310 and the radiators of the second radiator array 320 may be connected to a separate feeding structure disposed on the circuit board 305.

Reference structures may be defined as a control group for indicating performance of the antenna module 200 according to various embodiments of the present disclosure. An antenna structure in which the third radiator array 330 is not disposed and only the first radiator array 310 and the second radiator array 320 are disposed may be referred to as a first structure. A structure in which the 1-2 patch radiator 312 of the first radiator array 310 and the 2-2 patch radiator 322 of the second radiator array 320 are disposed to overlap the 3-1 patch radiator 331 of the third radiator array 330 (e.g., function as a triple band antenna element), and the 1-4 patch radiator 314 of the first radiator array 310 and the 2-4 patch radiator 324 of the second radiator array 320 are disposed to overlap the 3-2 patch radiator 332 of the third radiator array 330, may be referred to as a second structure. A structure in which the 3-1 patch radiator 331 of the third radiator array 330 is disposed to overlap the 1-1 patch radiator 311 and the 1-2 patch radiator 312 of the first radiator array 310 (likewise, also disposed to overlap the 2-1 patch radiator 321 and the 2-2 patch radiator 322 of the second radiator array 320), and the 3-2 patch radiator 332 of the third radiator array 330 is disposed to overlap the 1-3 patch radiator 313 and the 1-4 patch radiator 314 of the first radiator array 310 (likewise, also disposed to overlap the 2-3 patch radiator 323 and the 2-4 patch radiator 324 of the second radiator array 320), may be referred to as a third structure. In the third structure, a shape of a patch portion of each patch radiator (e.g., the 3-1 patch radiator 331 or the 3-2 patch radiator 332) of the third radiator array 330 may be a rectangular patch shape.

A fourth structure according to various embodiments of the present disclosure may indicate a structure having a shape in which the patch radiators of the first radiator array 310, the patch radiators of the second radiator array 320, and the patch radiators of the third radiator array 330 are disposed in the same manner as the third structure, but the patch portion (e.g., a first patch portion 451, a second patch portion 452, a first patch portion 751, or a second patch portion 752) of each patch radiator (e.g., the 3-1 patch radiator 331, or the 3-2 patch radiator 332) of the third radiator array 330 is cut (e.g., a notch is formed).

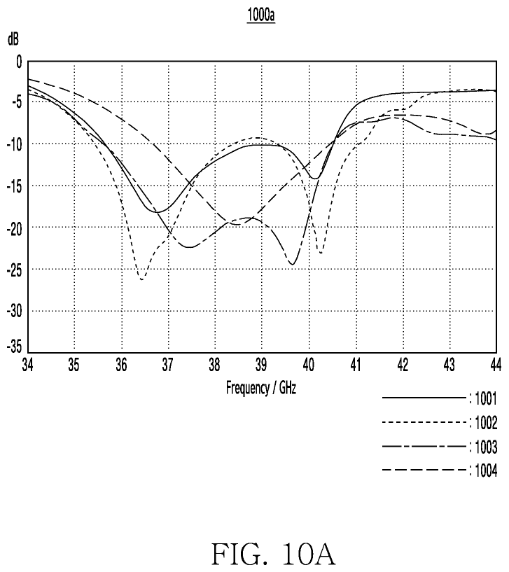

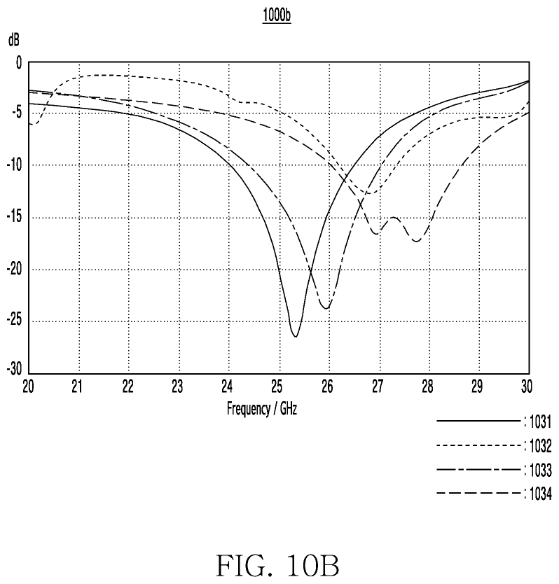

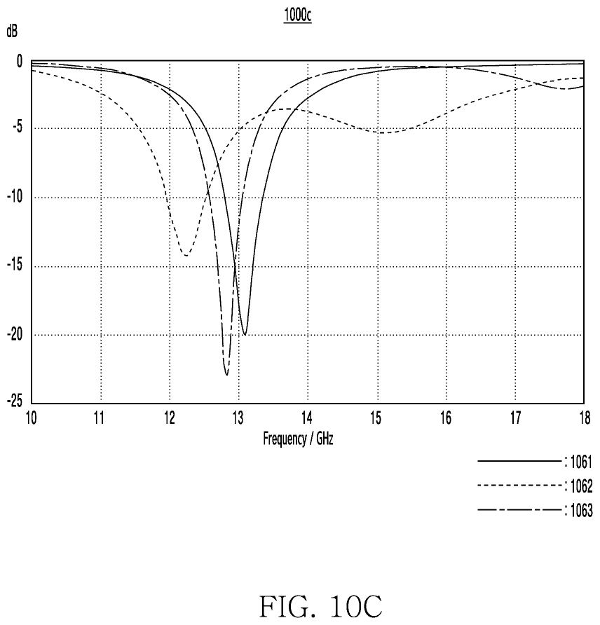

Hereinafter, examples of the performance of the antenna module 200 according to various embodiments of the present disclosure will be described in greater detail below with reference to FIGS. 10A, 10B, 10C, 11A, 11B, 11C, 12A, and 12B.

FIGS. 10A, 10B, and 10C are graphs illustrating an S-parameter (e.g., a reflection coefficient, S11) for each radiator disposition structure according to various embodiments.

Referring to FIG. 10A, a graph 1000a indicates a reflection coefficient of a second radiator array 320 for a second frequency band (e.g., a frequency band of FR2 greater than or equal to about 24.25 GHz, or a band of about 39 GHz). A horizontal axis of the graph 1000a indicates a frequency (unit: GHz) and a vertical axis of the graph 1000a indicates a reflection coefficient (unit: dB). A first line 1001 indicates a reflection coefficient for each frequency in a first structure. A second line 1002 indicates a reflection coefficient for each frequency in a second structure. A third line 1003 represents a reflection coefficient for each frequency in a third structure. A fourth line 1004 represents a reflection coefficient for each frequency in a fourth structure. In the band of about 39 GHz, it may be identified that the reflection coefficient of the fourth structure is equivalent to the reflection coefficient of the first structure.

Referring to FIG. 10B, a graph 1000b indicates a reflection coefficient of a first radiator array 310 for a first frequency band (e.g., a frequency band of FR2 greater than or equal to about 24.25 GHz, a band of about 26 GHz, or a band of about 28 GHz). A horizontal axis of the graph 1000b indicates a frequency (unit: GHz), and a vertical axis of the graph 1000b indicates a reflection coefficient (unit: dB). A first line 1031 indicates a reflection coefficient for each frequency in the first structure. A second line 1032 indicates a reflection coefficient for each frequency in the second structure. A third line 1033 indicates a reflection coefficient for each frequency in the third structure. A fourth line 1034 indicates a reflection coefficient for each frequency in the fourth structure. A frequency domain having a reflection coefficient of less than or equal to about −10 dB may correspond to a bandwidth. It may be identified that a bandwidth in the fourth structure is equivalent to a bandwidth in the first structure when there is no third radiator array 330. It may be identified that the bandwidth in the fourth structure is formed to be wider than a bandwidth in the second structure or the third structure.

Referring to FIG. 10C, a graph 1000c indicates a reflection coefficient of a third radiator array 330 for a third frequency band (e.g., a frequency band of FR3 greater than or equal to about 7.125 GHz and less than about 24.25 GHz, a band of about 12 GHz, or a band of about 15 GHz). A horizontal axis of the graph 1000c indicates a frequency (unit: GHz) and a vertical axis of the graph 1000c indicates a reflection coefficient (unit: dB). A first line 1061 indicates a reflection coefficient for each frequency in the second structure. A second line 1062 indicates a reflection coefficient for each frequency in the third structure. A third line 1063 represents a reflection coefficient for each frequency in the fourth structure. In a band of about 13 GHz, it may be identified that the reflection coefficient of the fourth structure is lower than that of other structures.

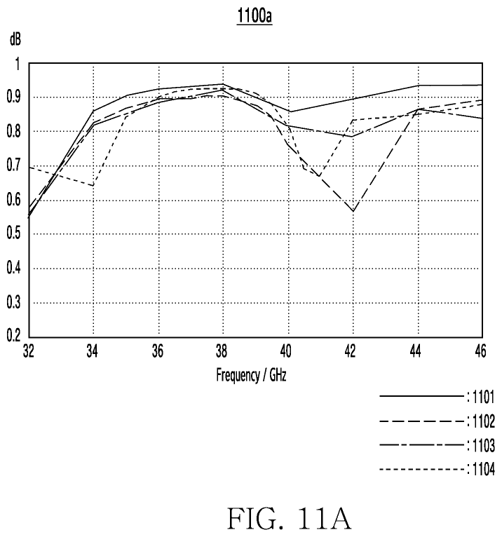

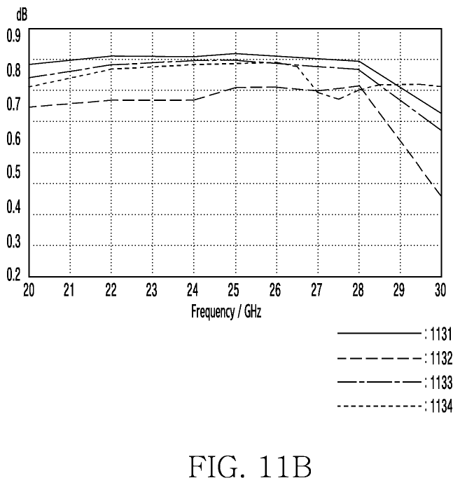

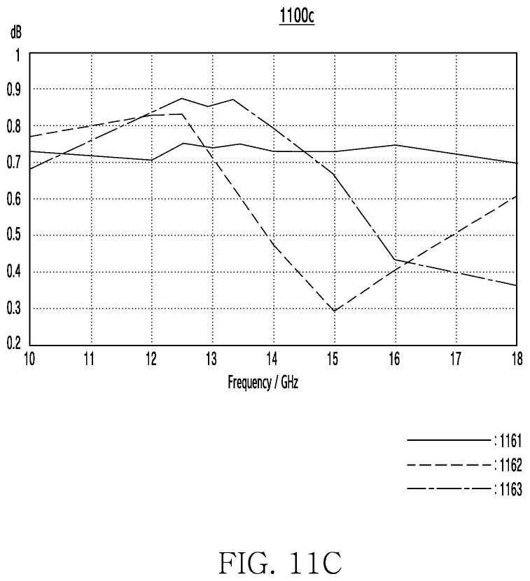

FIGS. 11A, 11B, and 11C are graphs illustrating radiation efficiency for each radiator disposition structure according to various embodiments.

Referring to FIG. 11A, a graph 1100a indicates a radiation efficiency of a second radiator array 320 for a second frequency band (e.g., a frequency band of FR2 greater than or equal to about 24.25 GHz, or a band of about 39 GHz). A horizontal axis of the graph 1100a indicates a frequency (unit: GHz), and a vertical axis of the graph 1100a indicates radiation efficiency. A first line 1101 indicates radiation efficiency for each frequency in a first structure. A second line 1102 indicates radiation efficiency for each frequency in a second structure. A third line 1103 indicates radiation efficiency for each frequency in a third structure. A fourth line 1104 indicates radiation efficiency for each frequency in a fourth structure. It may be identified that the radiation efficiency of the fourth structure is equivalent to the radiation efficiency of the first structure in the band of about 39 GHz.

Referring to FIG. 11B, a graph 1100b indicates radiation efficiency of a first radiator array 310 for a first frequency band (e.g., a frequency band of FR2 greater than or equal to about 24.25 GHz, a band of about 26 GHz, or a band of about 28 GHz). A horizontal axis of the graph 1100b indicates a frequency (unit: GHz), and a vertical axis of the graph 1100b indicates radiation efficiency. A first line 1131 indicates radiation efficiency for each frequency in the first structure. A second line 1132 indicates radiation efficiency for each frequency in the second structure. A third line 1133 indicates radiation efficiency for each frequency in the third structure. A fourth line 1134 indicates radiation efficiency for each frequency in the fourth structure.

Referring to FIG. 11C, a graph 1100c indicates radiation efficiency of a third radiator array 330 for a third frequency band (e.g., a frequency band of FR3 greater than or equal to about 7.125 GHz and less than about 24.25 GHz, a band of about 12 GHz, or a band of about 15 GHz). A horizontal axis of the graph 1100c indicates a frequency (unit: GHz), and a vertical axis of the graph 1100c indicates radiation efficiency. A first line 1161 indicates radiation efficiency for each frequency in the second structure. A second line 1162 indicates radiation efficiency for each frequency in the third structure. A third line 1163 indicates radiation efficiency for each frequency in the fourth structure. It may be identified that the radiation efficiency of the fourth structure is higher than that of other structures in a band of about 13 GHz.

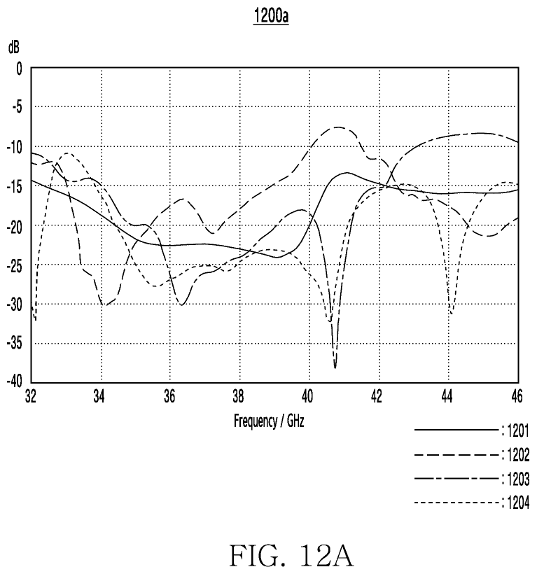

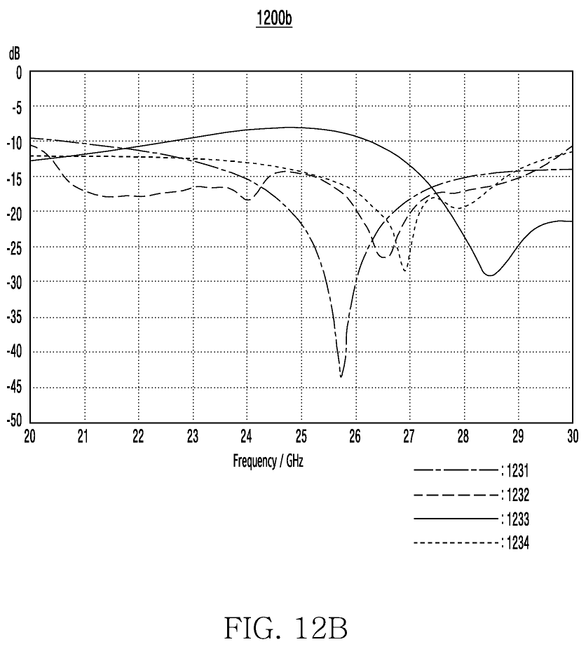

FIGS. 12A and 12B are graphs illustrating polarization isolation for each radiator disposition structure according to various embodiments. The polarization isolation may indicate a degree of independence between two polarizations (e.g., a vertical polarization and a horizontal polarization, a (+) 45 degrees polarization and a (−) 45 degrees polarization). As the polarization isolation is larger, since a degree to which a signal transmitted in one polarization is transferred or interfered with another, it may indicate that a gain according to polarization diversity is high.

Referring to FIG. 12A, a graph 1200a indicates polarization isolation of a second radiator array 320 for a second frequency band (e.g., a frequency band of FR2 greater than or equal to about 24.25 GHz, or a band of about 39 GHz). A horizontal axis of the graph 1200a indicates frequency (unit: GHz) and a vertical axis of the graph 1200a indicates polarization isolation (unit: dB). A first line 1201 indicates polarization isolation for each frequency in a first structure. A second line 1202 indicates polarization isolation for each frequency in a second structure. A third line 1203 indicates polarization isolation for each frequency in a third structure. A fourth line 1204 indicates polarization isolation for each frequency in a fourth structure. It may be identified that the polarization isolation of the fourth structure is equivalent to the polarization isolation of the first structure in the band of about 39 GHz.

Referring to FIG. 12B, a graph 1200b indicates polarization isolation of a first radiator array 310 for a first frequency band (e.g., a frequency band of FR2 greater than or equal to about 24.25 GHz, a band of about 26 GHz, or a band of about 28 GHz). A horizontal axis of the graph 1200b indicates frequency (unit: GHz) and a vertical axis of the graph 1200b indicates polarization isolation (unit: dB). A first line 1231 indicates polarization isolation for each frequency in the first structure. A second line 1232 indicates polarization isolation for each frequency in the second structure. A third line 1233 indicates polarization isolation for each frequency in the third structure. A fourth line 1234 indicates polarization isolation for each frequency in the fourth structure. It may be identified that the polarization isolation of the fourth structure is equivalent to the polarization isolation of the first structure in a band of about 29 GHz.

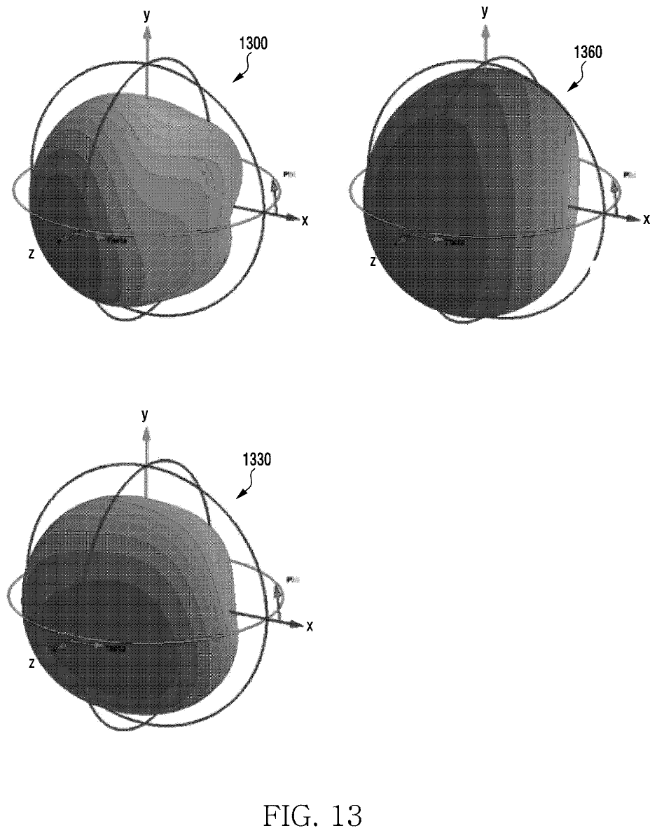

FIG. 13 includes diagrams illustrating examples of radiation patterns for each radiator array (e.g., a first radiator array 310, a second radiator array 320, or a third radiator array 330) according to various embodiments.

Referring to FIG. 13, an example 1300 indicates a radiation pattern of the second radiator array 320 for a second frequency band (e.g., a frequency band of FR2 greater than or equal to about 24.25 GHz, or a band of about 39 GHz). As an example, the second radiator array 320 may have a beam width of about 60.5 degrees in a xz plane, a beam width of about 93.7 degrees in a yz plane, and a gain characteristic of about 6.6 dB. An example 1330 indicates a radiation pattern of the first radiator array 310 for a first frequency band (e.g., a frequency band of FR2 greater than or equal to about 24.25 GHz, a band of about 26 GHz, or a band of about 28 GHz). As an example, the first radiator array 310 may have a beam width of about 115 degrees in the xz plane, a beam width of about 95.4 degrees in the yz plane, and a gain characteristic of about 5.6 dB. An example 1360 indicates a radiation pattern of the third radiator array 330 for a third frequency band (e.g., a frequency band of FR3 greater than or equal to about 7.125 GHz and less than about 24.25 GHz, a band of about 12 GHz, or a band of about 15 GHz). As an example, the third radiator array 330 may have a beam width of about 94.5 degrees in the xz plane, a beam width of about 184 degrees in the yz plane, and a gain characteristic of about 3.4 dB.

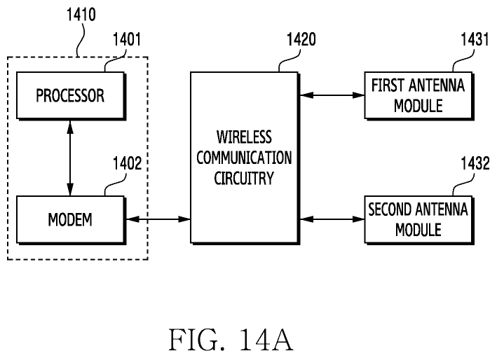

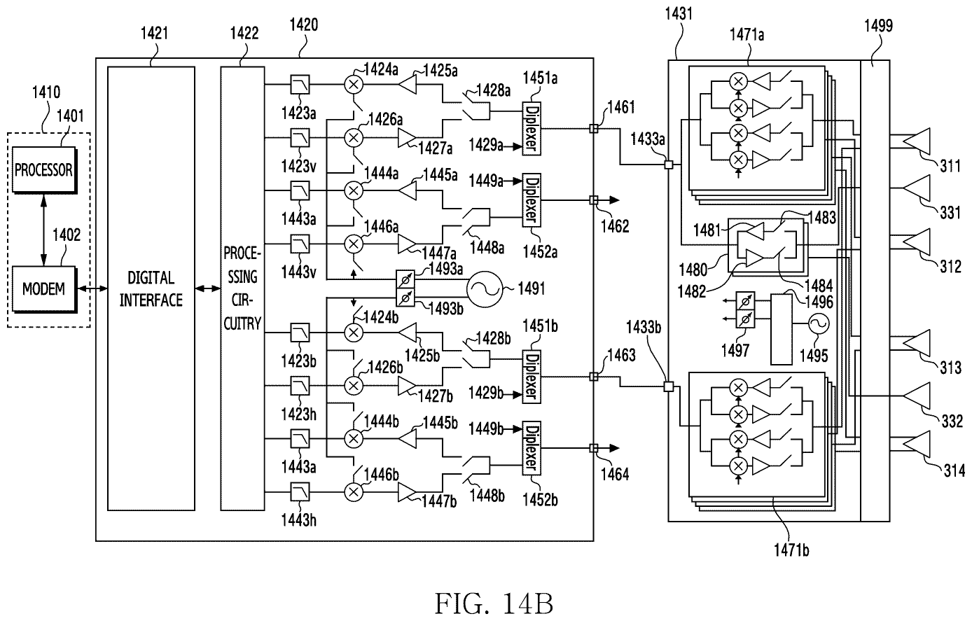

FIGS. 14A and 14B are diagrams illustrating an example configuration of an electronic device (e.g., an electronic device 101) including an antenna module (e.g., an antenna module 200) according to various embodiments. Configurations and descriptions illustrated in FIGS. 14A and 14B are examples and are not limiting structures of the electronic device 101 according to various embodiments. The same reference number may be used to indicate the same component and/or the same description.

Referring to FIG. 14A, the electronic device 101 may include a processor (e.g., including processing circuitry) 1401, a modem 1402, wireless communication circuitry 1420, and/or at least one antenna module (e.g., a first antenna module 1431, or a second antenna module 1432). For example, the processor 1401 may be an application processor (AP) (e.g., the main processor 121 of FIG. 1). For example, the modem 1402 may be a communication processor (CP) (e.g., the auxiliary processor 123 of FIG. 1). As a non-limiting example, the processor 1401 and the modem 1402 may be implemented as one chip, and according to an implementation example, the processor 1401 and the modem 1402 may be collectively referred to as a processor 1410. The processor 1410 may be configured to perform functions of the processor 1401 and/or functions of the modem 1402. The electronic device 101 may include the wireless communication circuitry 1420. The wireless communication circuitry 1420 may include components for processing a transmission signal. For example, the wireless communication circuitry 1420 may include a digital to analog converter (DAC) for converting a digital signal into an analog signal, a mixer and an oscillator for up-conversion, and/or a power amplifier (PA). The wireless communication circuitry 1420 may include components for processing a reception signal. For example, the wireless communication circuitry 1420 may include an analog to digital converter (ADC) for converting an analog signal into a digital signal, a mixer and an oscillator for down-conversion, and/or a low noise amplifier (LNA). The at least one antenna module may include the antenna module 200 according to various embodiments of the present disclosure described through FIGS. 1 to 13. For the first antenna module 1431 and the second antenna module 1432, descriptions of the antenna module 200 may be referenced.

According to an embodiment, the wireless communication circuitry 1420 may be configured to perform frequency conversion (e.g., IF conversion) for signals in a first frequency band (e.g., a frequency band of FR2 greater than or equal to about 24.25 GHz, a band of about 26 GHz, or a band of about 28 GHz) and/or signals for a second frequency band (e.g., a frequency band of FR2 greater than or equal to about 24.25 GHz, or a band of about 39 GHz). An intermediate frequency (e.g., a frequency of about 8 GHz to 13 GHz) may be used when up-converting or down-converting a frequency of an ultra-high frequency band. For example, signals up-converted to the intermediate frequency may be up-converted to a frequency of the first frequency band through RFIC of an antenna module (e.g., the first antenna module 1431 and the second antenna module 1432). When signals are received on the first frequency band, signals down-converted to the intermediate frequency through the RFIC may be converted into baseband signals through the wireless communication circuitry 1420.

According to an embodiment, the wireless communication circuitry 1420 may be configured to perform frequency conversion (e.g., up-conversion, or down-conversion) for signals in a third frequency band (e.g., a frequency band of FR3 greater than or equal to about 7.125 GHz and less than about 24.25 GHz, a band of about 12 GHz, or a band of about 15 GHz). For example, the frequency-converted signals may be radiated through the antenna module (e.g., the first antenna module 1431, or the second antenna module 1432) and a 3-1 patch radiator 331 and/or a 3-2 patch radiator 332. The antenna module may include feeding paths (e.g., a feeding line, or a feeding via) for feeding the frequency-converted signals to a corresponding antenna. As a non-limiting example, separate frequency conversion may not be performed in the antenna module.

Referring to FIG. 14B, more detailed components of the wireless communication circuitry 1420 and the first antenna module 1431 of the electronic device 101 are illustrated. The wireless communication circuitry 1420 may include a digital interface (e.g., including various circuitry) 1421 (e.g., a MIPI interface) for communication with the processor 1410 (or the modem 1402) and processing circuitry 1422 for analog-to-digital signal conversion. For example, the processing circuitry 1422 for analog-to-digital signal conversion may include ADC and/or DAC. The wireless communication circuitry 1420 may include a processing chain for the first antenna module 1431 and a processing chain for the second antenna module 1432. The processing chain for the first antenna module 1431 may include a first processing chain for a first polarization (e.g., a vertical polarization) and a second processing chain for a second polarization (e.g., a horizontal polarization). The processing chain for the second antenna module 1432 may include a third processing chain for the first polarization and a fourth processing chain for the second polarization. The wireless communication circuitry 1420 may include an oscillator 1491 (e.g., LO) for providing a reference frequency to a mixer included in each processing chain. Each processing chain may be referred to as transmit/receive processing circuitry in terms of performing both transmission signal processing and reception signal processing.

According to an embodiment, in the first antenna module 1431, the first processing chain for the first polarization may include components (e.g., a transmission filter 1423v, a mixer 1426a, or PA 1427a) for transmission signal processing and components (e.g., a reception filter 1423a, a mixer 1424a, or LNA 1425a) for reception signal processing. The first processing chain may include a transmission/reception switch 1428a and a diplexer 1451a. The transmission/reception switch 1428a may be used to transmit a transmission signal passing through the components for transmission signal processing to the first antenna module 1431 or to transmit a reception signal to the components for reception signal processing. The diplexer 1451a may be connected to a first port 1461. A reference clock signal 1429a may be input to the diplexer 1451a together with an output (e.g., the transmission signal) of the transmission/reception switch 1428a. The reference clock signal 1429a may be used for clock synchronization in the antenna module (e.g., the first antenna module 1431, or the second antenna module 1432).

According to an embodiment, in the first antenna module 1431, the second processing chain for the second polarization may include components (e.g., a transmission filter 1423h, a mixer 1426b, or PA 1427b) for transmission signal processing and components (e.g., a reception filter 1423b, a mixer 1424b, or LNA 1425b) for reception signal processing. The second processing chain may include a transmission/reception switch 1428b and a diplexer 1451b. The transmission/reception switch 1428b may be used to transmit a transmission signal passing through the components for processing the transmission signal to the first antenna module 1431 or to transmit a reception signal to the components for processing the reception signal. The diplexer 1451b may be connected to a third port 1463. A reference clock signal 1429b may be input to the diplexer 1451b together with an output (e.g., the transmission signal) of the transmission/reception switch 1428b. The reference clock signal 1429b may be used for clock synchronization in the antenna module (e.g., the first antenna module 1431, or the second antenna module 1432).

According to an embodiment, in the second antenna module 1432, the third processing chain for the first polarization may include components (e.g., a transmission filter 1443v, a mixer 1446a, or PA 1447a) for transmission signal processing and components (e.g., a reception filter 1443a, a mixer 1444a, or LNA 1445a) for reception signal processing. The third processing chain may include a transmission/reception switch 1448a and a diplexer 1452a. The transmission/reception switch 1448a may be used to transmit a transmission signal passing through the components for processing the transmission signal to the second antenna module 1432, or to transmit a reception signal to the components for processing the reception signal. The diplexer 1452a may be connected to a second port 1462. A reference clock signal 1449a may be input to the diplexer 1452a together with an output (e.g., the transmission signal) of the transmission/reception switch 1448a. The reference clock signal 1449a may be used for clock synchronization in the antenna module (e.g., the first antenna module 1431, or the second antenna module 1432).

According to an embodiment, in the second antenna module 1432, the fourth processing chain for the second polarization may include components (e.g., a transmission filter 1443h, a mixer 1446b, or PA 1447b) for transmission signal processing and components (e.g., a reception filter 1443b, a mixer 1444b, or LNA 1445b) for reception signal processing. The fourth processing chain may include a transmission/reception switch 1448b and a diplexer 1452b. The transmission/reception switch 1448b may be used to transmit a transmission signal passing through the components for processing the transmission signal to the second antenna module 1432, or to transmit a reception signal to the components for processing the reception signal. The diplexer 1452b may be connected to a fourth port 1464. A reference clock signal 1449b may be input to the diplexer 1452b together with an output (e.g., the transmission signal) of the transmission/reception switch 1448b. The reference clock signal 1449b may be used for clock synchronization in the antenna module (e.g., the first antenna module 1431, or the second antenna module 1432).

Various methods may be used to adjust a phase of an RF signal. According to an embodiment, a method of shifting a phase of a signal of a baseband may be used. According to an embodiment, a method of shifting a phase of a signal of an IF frequency may be used. According to an embodiment, a method of shifting a phase of a signal of an RF frequency may be used. According to an embodiment, the method of shifting the phase of the signal of the IF frequency and the method of shifting the phase of the signal of the RF frequency may be used together. For example, the wireless communication circuitry 1420 may include phase shifters (e.g., a first phase shifter 1493a, or a second phase shifter 1493b) connected to the oscillator 1491 to shift the phase of the signal of the IF frequency. The first phase shifter 1493a may be configured to control (e.g., change) a phase for signals having the first polarization. The second phase shifter 1493b may be configured to control (e.g., change) a phase for signals having the second polarization. As the phase shifters (e.g., the first phase shifter 1493a or the second phase shifter 1493b) are connected to the oscillator 1491 rather than a path of each processing chain, circuitry may be efficiently designed.

According to an embodiment, the wireless communication circuitry 1420 may be connected to the first antenna module 1431 and/or the second antenna module 1432. For example, the first port 1461 of the wireless communication circuitry 1420 may be connected to a first port 1433a of the first antenna module 1431. For example, the second port 1462 of the wireless communication circuitry 1420 may be connected to the second antenna module 1432. For example, the third port 1463 of the wireless communication circuitry 1420 may be connected to a second port 1433b of the first antenna module 1431. For example, the fourth port 1464 of the wireless communication circuitry 1420 may be connected to the second antenna module 1432. Hereinafter, although described based on the first antenna module 1431, a description of the first antenna module 1431 may be applied to the second antenna module 1432 in the same or similar manner.

According to an embodiment, the first antenna module 1431 may include RF processing circuitry. For example, the first antenna module 1431 may include first RF processing circuitry 1471a for processing signals having the first polarization (e.g., the vertical polarization) and second RF processing circuitry 1471b for processing signals having the second polarization (e.g., the horizontal polarization). For example, the first RF processing circuit 1471a may include a mixer, an oscillator, PA, and/or LNA for signals in the first frequency band (e.g., the frequency band of FR2 greater than or equal to about 24.25 GHz, the band of about 26 GHz, or the band of about 28 GHz). The first RF processing circuitry 1471a may include a mixer, an oscillator, PA, and/or LNA for signals in the second frequency band (e.g., the frequency band of FR2 greater than or equal to about 24.25 GHz, or the band of about 39 GHz). For example, the second RF processing circuitry 1471b may include a mixer, an oscillator, PA, and/or LNA for signals in the first frequency band (e.g., the frequency band of FR2 greater than or equal to about 24.25 GHz, the band of about 26 GHz, or the band of about 28 GHz). The second RF processing circuitry 1471b may include a mixer, an oscillator, PA, and/or LNA for signals in the second frequency band (e.g., the frequency band of FR2 greater than or equal to about 24.25 GHz, or the band of about 39 GHz). As a non-limiting example, the first RF processing circuitry 1471a and the second RF processing circuitry 1471b may be implemented as a single chip (e.g., RFIC) or as separate chips. For example, the first antenna module 1431 may include components (e.g., LNA 1481, PA 1482, a reception switch 1483, or a transmission switch 1484) to process signals in the third frequency band (e.g., a frequency band of FR3 greater than or equal to about 7.125 GHz and less than about 24.25 GHz, a band of about 12 GHz, or a band of about 15 GHz).

According to an embodiment, the first antenna module 1431 may include components for phase control for beamforming. For example, the first antenna module 1431 may include an oscillator 1495 (e.g., LO) to provide a reference frequency to each mixer. For example, the first antenna module 1431 may include a divider 1496 for branching reference frequencies of the oscillator 1495 to each path and phase shifters 1497 connected to the divider 1496. In order to control a beamforming gain, the phase shifters 1497 may be configured to change a phase of RF signals to be transmitted to each patch radiator.

According to an embodiment, the first antenna module 1431 may include feeding circuitry 1499. The feeding circuitry 1499 may include a circuit wiring for connecting a plurality of RF components of the first antenna module 1431 to a patch radiator (e.g., a 1-1 patch radiator 311, a 1-2 patch radiator 312, a 1-3 patch radiator 313, a 1-4 patch radiator 314, a 3-1 patch radiator 331, and/or a 3-2 patch radiator 332). For example, the feeding circuitry 1499 may include a feeding via formed to penetrate layers or a feeding line formed on a layer to feed a signal to the patch radiator.

In FIGS. 14A and 14B, an example in which two antenna modules (e.g., the first antenna module 1431, or the second antenna module 1432) are connected to wireless communication circuitry (e.g., the wireless communication circuit 1420) have been described, but the present disclosure is not limited thereto. According to an embodiment, the electronic device 101 may include one or three or more antenna modules. One antenna module (e.g., the first antenna module 1431, or the antenna module 200) may be connected to the wireless communication circuitry 1420.

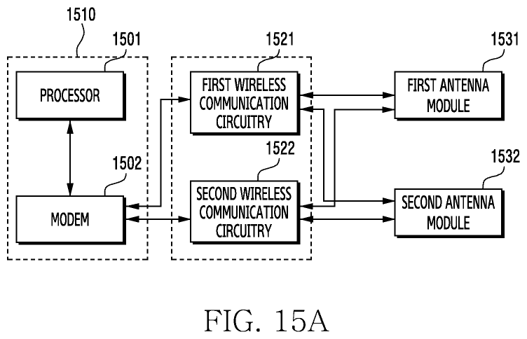

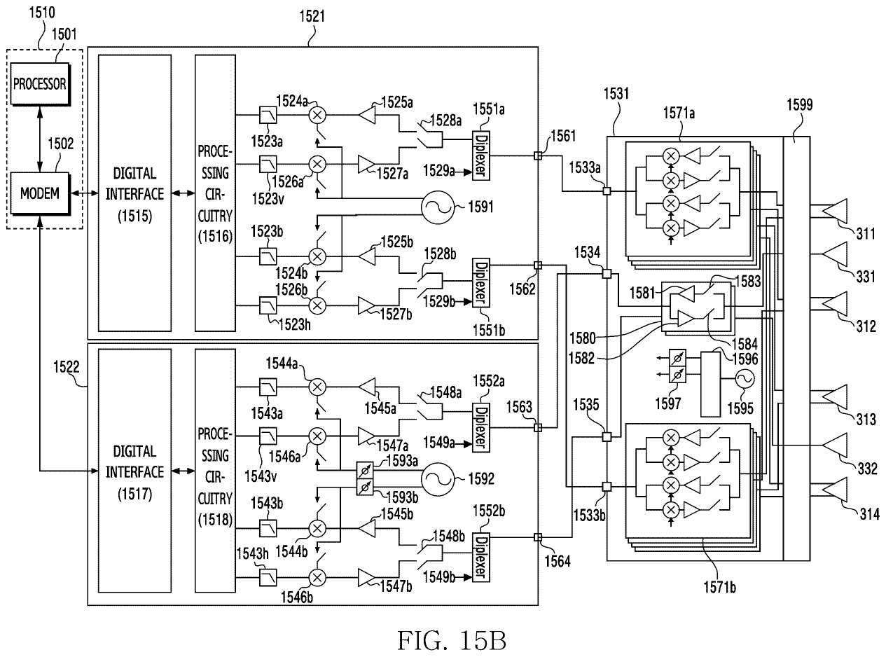

In FIGS. 14A and 14B, a circuitry structure has been described in which the wireless communication circuitry (e.g., the wireless communication circuitry 1420) performs IF signal processing in a FR2 band (e.g., which is a mmWave band, the first frequency band of FIGS. 1 to 13, or the second frequency band of FIGS. 1 to 13) together with RF signal processing in a FR3 band (e.g., a frequency band of greater than or equal to about 7.125 GHz or less than about 24.25 GHz, or the third frequency band of FIGS. 1 to 13), but the present disclosure are is limited thereto. Hereinafter, an example of an electronic device respectively including circuitry for processing the IF signal and circuitry for processing the RF signal will be described in greater detail below with reference to FIGS. 15A and 15B.

FIGS. 15A and 15B illustrate an example of an electronic device (e.g., an electronic device 101) including an antenna module (e.g., an antenna module 200). Configurations and descriptions illustrated in FIGS. 15A and 15B are examples and are not limiting structures of the electronic device 101 according to various embodiments. The same reference number may be used to indicate the same component and/or the same description.

Referring to FIG. 15A, the electronic device 101 may include a processor (e.g., including processing circuitry) 1501, a modem 1502, first wireless communication circuitry 1521, second wireless communication circuitry 1522, and/or at least one antenna module (e.g., a first antenna module 1531, or a second antenna module 1532). For example, the processor 1501 may be an application processor (AP) (e.g., the main processor 121 of FIG. 1). For example, the modem 1502 may be a communication processor (CP) (e.g., the auxiliary processor 123 of FIG. 1). As a non-limiting example, the processor 1501 and the modem 1502 may be implemented as one chip, and according to an implementation example, the processor 1501 and the modem 1502 may be collectively referred to as a processor 1510. The processor 1510 may be configured to perform functions of the processor 1501 and/or functions of the modem 1502.

The electronic device 101 may include the first wireless communication circuitry 1521. The first wireless communication circuitry 1521 may include components for signal processing in a FR2 band (e.g., a first frequency band or a second frequency band). The electronic device 101 may include the second wireless communication circuit 1522. The second wireless communication circuitry 1522 may include components for signal processing in a FR3 band (e.g., a third frequency band). Each of the first wireless communication circuitry 1521 and the second wireless communication circuitry 1522 may include components for processing a transmission signal. For example, the components for processing the transmission signal may include a digital to analog converter (DAC) for converting a digital signal into an analog signal, a mixer and an oscillator for up-conversion, and/or a power amplifier (PA). Each of the first wireless communication circuitry 1521 and the second wireless communication circuitry 1522 may include components for processing a reception signal. For example, the components for processing the reception signal may include an analog to digital converter (ADC) for converting an analog signal into a digital signal, a mixer and an oscillator for down-conversion, and/or a low noise amplifier (LNA). The at least one antenna module may include the antenna module 200 according to various embodiments of the present disclosure described through FIGS. 1 to 13. For the first antenna module 1531 and the second antenna module 1532, descriptions of the antenna module 200 may be referenced.

According to an embodiment, the first wireless communication circuitry 1521 may be configured to perform frequency conversion (e.g., IF conversion) for signals in the first frequency band (e.g., a frequency band of FR2 greater than or equal to about 24.25 GHz, a band of about 26 GHz, or a band of about 28 GHz) and/or signals in the second frequency band (e.g., a frequency band of FR2 greater than or equal to about 24.25 GHz, or a band of about 39 GHz). An intermediate frequency (e.g., a frequency of about 8 GHz to 13 GHz) may be used to avoid putting a strain on RF components, when up-converting or down-converting a frequency of an ultra-high frequency band. For example, signals up-converted to the intermediate frequency may be up-converted to a frequency of the first frequency band through RFIC of an antenna module (e.g., the first antenna module 1531 and the second antenna module 1532). When signals are received on the first frequency band, signals down-converted to the intermediate frequency through the RFIC may be converted into baseband signals through the first wireless communication circuitry 1521.

According to an embodiment, the second wireless communication circuitry 1522 may be configured to perform frequency conversion (e.g., up-conversion, or down-conversion) for signals in a third frequency band (e.g., a frequency band of FR3 greater than or equal to about 7.125 GHz and less than about 24.25 GHz, a band of about 12 GHz, or a band of about 15 GHz). For example, the frequency-converted signals may be radiated through the antenna module (e.g., the first antenna module 1531, or the second antenna module 1532) and a 3-1 patch radiator 331 and/or a 3-2 patch radiator 332. The antenna module may include feeding paths (e.g., a feeding line or a feeding via) for feeding the frequency-converted signals to a corresponding antenna. As a non-limiting example, separate frequency conversion may not be performed in the antenna module.

Referring to FIG. 15B, more detailed components of the first wireless communication circuitry 1521, the second wireless communication circuitry 1522, and the first antenna module 1531 of the electronic device 101 are illustrated. The first wireless communication circuitry 1521 may include a digital interface 1515 (e.g., a MIPI interface) for communication with the processor 1510 (or the modem 1502) and processing circuitry 1516 for analog-to-digital signal conversion. The second wireless communication circuitry 1522 may include a digital interface 1517 (e.g., a MIPI interface) for communication with the processor 1510 (or the modem 1502) and processing circuitry 1518 for analog-to-digital signal conversion. The first wireless communication circuitry 1521 may include a processing chain for signal processing in a FR2 frequency band (e.g., the first frequency band or the second frequency band). The second wireless communication circuitry 1522 may include a processing chain for signal processing in a FR3 frequency band (e.g., the third frequency band). The processing chain for signal processing in the FR2 frequency band (e.g., the first frequency band, or the second frequency band) may include a first processing chain for a first polarization (e.g., a vertical polarization) and a second processing chain for a second polarization (e.g., a horizontal polarization). The processing chain for signal processing in the FR3 frequency band (e.g., the third frequency band) may include a third processing chain for the first polarization and a fourth processing chain for the second polarization. The first wireless communication circuitry 1521 may include an oscillator 1591 (e.g., LO) for providing a reference frequency to a mixer included in each processing chain. The second wireless communication circuitry 1522 may include an oscillator 1592 (e.g., LO) for providing a reference frequency to the mixer included in each processing chain. Each processing chain may be referred to as transmit/receive processing circuitry in terms of performing both transmission signal processing and reception signal processing.

According to an embodiment, the first processing chain for the first polarization in the frequency band of FR2 may include components (e.g., a transmission filter 1523v, a mixer 1526a, or PA 1527a) for transmission signal processing and components (e.g., a reception filter 1523a, a mixer 1524a, or LNA 1525a) for reception signal processing. The first processing chain may include a transmission/reception switch 1528a and a diplexer 1551a. The transmission/reception switch 1528a may be used to transmit a transmission signal passing through the components for processing the transmission signal to the antenna module (e.g., the first antenna module 1531 or the second antenna module 1532) or to transmit a reception signal to the components for processing the reception signal. The diplexer 1551a may be connected to a first port 1561. A reference clock signal 1529a may be input to the diplexer 1551a together with an output (e.g., the transmission signal) of the transmission/reception switch 1528a. The reference clock signal 1529a may be used for clock synchronization in the antenna module (e.g., the first antenna module 1531, or the second antenna module 1532).

According to an embodiment, the second processing chain for the second polarization in the frequency band of FR2 may include components (e.g., a transmission filter 1523h, a mixer 1526b, or PA 1527b) for transmission signal processing and components (e.g., a reception filter 1523b, a mixer 1524b, or LNA 1525b) for reception signal processing. The second processing chain may include a transmission/reception switch 1528b and a diplexer 1551b. The transmission/reception switch 1528b may be used to transmit a transmission signal passing through the components for processing the transmission signal to the antenna module (e.g., the first antenna module 1531 or the second antenna module 1532) or to transmit a reception signal to the components for processing the reception signal. The diplexer 1551b may be connected to a second port 1562. A reference clock signal 1529b may be input to the diplexer 1551b together with an output (e.g., the transmission signal) of the transmission/reception switch 1528b. The reference clock signal 1529b may be used for clock synchronization in the antenna module (e.g., the first antenna module 1531, or the second antenna module 1532).

According to an embodiment, the third processing chain for the first polarization in the frequency band of FR3 may include components (e.g., a transmission filter 1543v, a mixer 1546a, or PA 1547a) for transmission signal processing and components (e.g., a reception filter 1543a, a mixer 1544a, or LNA 1545a) for reception signal processing. The third processing chain may include a transmission/reception switch 1548a and a diplexer 1552a. The transmission/reception switch 1548a may be used to transmit a transmission signal passing through the components for processing the transmission signal to the antenna module (e.g., the first antenna module 1531, or the second antenna module 1532) or to transmit a reception signal to the components for processing the reception signal. The diplexer 1552a may be connected to a third port 1563. A reference clock signal 1549a may be input to the diplexer 1552a together with an output (e.g., the transmission signal) of the transmission/reception switch 1548a. The reference clock signal 1549a may be used for clock synchronization in the antenna module (e.g., the first antenna module 1531, or the second antenna module 1532).

According to an embodiment, the fourth processing chain for the second polarization in the frequency band of FR3 may include components (e.g., a transmission filter 1543h, a mixer 1546b, or PA 1547b) for transmission signal processing and components (e.g., a reception filter 1543b, a mixer 1544b, or LNA 1545b) for reception signal processing. The fourth processing chain may include a transmission/reception switch 1548b and a diplexer 1552b. The transmission/reception switch 1548b may be used to transmit a transmission signal passing through the components for processing the transmission signal to the antenna module or to transmit a reception signal to the components for processing the reception signal. The diplexer 1552b may be connected to a fourth port 1564. A reference clock signal 1549b may be input to the diplexer 1552b together with an output (e.g., the transmission signal) of the transmission/reception switch 1548b. The reference clock signal 1549b may be used for clock synchronization in the antenna module (e.g., the first antenna module 1531, or the second antenna module 1532).

According to an embodiment, the first wireless communication circuitry 1521 may be connected to the first antenna module 1531 and/or the second antenna module 1532. For example, the first port 1561 of the first wireless communication circuitry 1521 may be connected to a first port 1533a of the first antenna module 1531. For example, the second port 1562 of the first wireless communication circuitry 1521 may be connected to a second port 1533b of the first antenna module 1531. For example, the third port 1563 of the second wireless communication circuitry 1522 may be connected to a third port 1534 of the first antenna module 1531. For example, the fourth port 1564 of the second wireless communication circuitry 1522 may be connected to a fourth port 1535 of the first antenna module 1531. Hereinafter, although described based on the first antenna module 1531, a description of the first antenna module 1531 may be applied to the second antenna module 1532 in the same or similar manner.

According to an embodiment, the first antenna module 1531 may include RF processing circuitry. For example, the first antenna module 1531 may include first RF processing circuitry 1571a for processing signals having the first polarization (e.g., the vertical polarization) and second RF processing circuitry 1571b for processing signals having the second polarization (e.g., the horizontal polarization). The first RF processing circuitry 1571a may be connected to the first port 1533a of the first antenna module 1531. The second RF processing circuitry 1571b may be connected to the second port 1533b of the first antenna module 1531. For example, the first RF processing circuitry 1571a may include a mixer, an oscillator, PA, and/or LNA for signals in the first frequency band (e.g., the frequency band of FR2 greater than or equal to about 24.25 GHz, the band of about 26 GHz, or the band of about 28 GHz). The first RF processing circuitry 1571a may include a mixer, an oscillator, PA, and/or LNA for signals in the second frequency band (e.g., the frequency band of FR2 greater than or equal to about 24.25 GHz, or the band of about 39 GHz). For example, the second RF processing circuitry 1571b may include a mixer, an oscillator, PA, and/or LNA for signals in the first frequency band (e.g., the frequency band of FR2 greater than or equal to about 24.25 GHz, the band of about 26 GHz, or the band of about 28 GHz). The second RF processing circuitry 1571b may include a mixer, an oscillator, PA, and/or LNA for signals in the second frequency band (e.g., the frequency band of FR2 greater than or equal to about 24.25 GHz, or the band of about 39 GHz). As a non-limiting example, the first RF processing circuitry 1571a and the second RF processing circuitry 1571b may be implemented as one chip (e.g., RFIC) or as separate chips. For example, the first antenna module 1531 may include components (e.g., LNA 1581, PA 1582, a reception switch 1583, or a transmission switch 1584) to process signals in the third frequency band (e.g., the frequency band of FR3 greater than or equal to about 7.125 GHz and less than about 24.25 GHz, the band of about 12 GHz, or the band of about 15 GHz).

According to an embodiment, the first antenna module 1531 may include components for phase control for beamforming. For example, the first antenna module 1531 may include an oscillator 1595 (e.g., LO) to provide a reference frequency to each mixer. For example, the first antenna module 1531 may include a divider 1596 for branching reference frequencies of the oscillator 1595 to each path and phase shifters 1597 connected to the divider 1596. In order to control a beamforming gain, the phase shifters 1597 may be configured to change a phase of RF signals to be transmitted to each patch radiator.

According to an embodiment, the first antenna module 1531 may include feeding circuitry 1599. The feeding circuit 1599 may include a circuit wiring for connecting a plurality of RF components of the first antenna module 1531 to a patch radiator (e.g., a 1-1 patch radiator 311, a 1-2 patch radiator 312, a 1-3 patch radiator 313, a 1-4 patch radiator 314, a 3-1 patch radiator 331, and/or a 3-2 patch radiator 332). For example, the feeding circuitry 1599 may include a feeding via formed to penetrate layers or a feeding line formed on a layer to feed a signal to the patch radiator.

The effects that can be obtained from the present disclosure are not limited to those described above, and any other effects not mentioned herein will be clearly understood by those having ordinary knowledge in the art to which the present disclosure belongs.

In FIGS. 14A, 14B, 15A, and 15B, an example in which an antenna module is disposed in an electronic device 101 communicating with a base station has been described, but the present disclosure is not limited thereto. A structure according to various embodiments of the present disclosure, may be applied not only to the electronic device 101 but also to the antenna module within base station equipment (e.g., the base station, or a radio unit (RU) of the base station) for communicating with the electronic device 101. The base station equipment supporting a plurality of frequency bands may include the circuitry structure of FIGS. 14A, 14B, 15A, and 15B.

In various example embodiments of the present disclosure, an electronic device 101 is provided. The electronic device 101 may comprise at least one processor 120, 1410, or 1510, wireless communication circuitry 192, 1420, 1521, or 1522 coupled to the at least one processor, and an antenna module 200 coupled to the wireless communication circuitry. The antenna module 200 may include a circuit board 305 on which a first radiator array 310 for a first frequency band, a second radiator array 320 for a second frequency band higher than the first frequency band, and a third radiator array 330 for a third frequency band lower than the first frequency band are disposed. The first radiator array 310 may include patch radiators having a first size, disposed on a first layer among a plurality of layers of the circuit board 305. The second radiator array 320 may include patch radiators having a second size smaller than the first size, disposed on a second layer above the first layer with respect to a side of the circuit board among the plurality of layers of the circuit board 305. The third radiator array 330 may include patch radiators having a third size larger than the first size, disposed on a third layer below the first layer with respect to the side of the circuit board 305 among the plurality of layers of the circuit board 305. The patch radiators disposed on the second layer may be disposed to overlap the patch radiators disposed on the first layer, respectively. The patch radiators disposed on the third layer may include a patch radiator having a first patch portion 451 partially overlapping with one of two adjacent patch radiators among the patch radiators disposed on the first layer and a second patch portion 452 partially overlapping with another of the two adjacent patch radiators. A gap 465 formed between the first patch portion 451 and the second patch portion 452 may be disposed on an area between the two adjacent patch radiators.

For example, the first patch portion 451 may have a shape in which a notch is formed on a second side opposite to a first side adjacent to the gap 465 in a direction toward the gap 465. The second patch portion 452 may have a shape symmetrical to the first patch portion 451 with respect to an axis related to the gap 465.

For example, the electronic device 101 may comprise a first set of conductive vias for connecting a ground layer of the circuit board 305 and the first patch portion 451, a second set of conductive vias for connecting the ground layer of the circuit board 305 and the second patch portion 452, and a feeding portion for providing signals of the third frequency band to the first patch portion 451.

For example, the two adjacent patch radiators in the first radiator array 310 may include a first patch radiator and a second patch radiator. The patch radiators disposed on the second layer in the second radiator array 320 may include a third patch radiator and a fourth patch radiator. The third patch radiator may be disposed to be fully overlapped with the first patch radiator when viewing the antenna module 200. The fourth patch radiator may be disposed to be fully overlapped with the second patch radiator when viewing the antenna module 200. The circuit board 305 may include a first feeding portion for providing signals having a first polarization to the first patch radiator of the first layer, a second feeding portion for providing signals having a second polarization to the first patch radiator of the first layer, a third feeding portion for providing signals having the first polarization to the second patch radiator of the first layer, a fourth feeding portion for providing signals having the second polarization to the second patch radiator of the first layer, a fifth feeding portion for providing signals having the first polarization to the third patch radiator of the second layer, a sixth feeding portion for providing signals having the second polarization to the third patch radiator of the second layer, a seventh feeding portion for providing signals having the first polarization to the fourth patch radiator of the second layer, and an eighth feeding portion for providing signals having the second polarization to the fourth patch radiator of the second layer.

For example, each of the first feeding portion and the second feeding portion may be positioned within an area of the first patch radiator and outside an area of the first patch portion 451 of the third radiator array 330, when viewing the antenna module 200. Each of the third feeding portion and the fourth feeding portion may be positioned within an area of the second patch radiator and outside an area of the second patch portion 452 of the third radiator array 330, when viewing the antenna module 200. Each of the fifth feeding portion and the sixth feeding portion may be positioned within an area of the third patch radiator and within the area of the first patch portion 451 of the third radiator array 330, when viewing the antenna module 200. Each of the seventh feeding portion and the eighth feeding portion may be positioned within an area of the fourth patch radiator and within the area of the second patch portion 452 of the third radiator array 330, when viewing the antenna module 200. The first patch portion 451 and the second patch portion 452 may be symmetrical with respect to an axis related to the gap 465. When viewing the antenna module 200, a position of the first feeding portion may be symmetrical to a position of the fourth feeding portion with respect to the axis. When viewing the antenna module 200, a position of the second feeding portion may be symmetrical to a position of the third feeding portion with respect to the axis. When viewing the antenna module 200, a position of the fifth feeding portion may be symmetrical to a position of the eighth feeding portion with respect to the axis. When viewing the antenna module 200, a position of the sixth feeding portion may be symmetrical to a position of the seventh feeding portion with respect to the axis.

For example, each of the first feeding portion and the second feeding portion may be positioned within an area of the first patch radiator and within an area of the first patch portion 451 of the third radiator array 330, when viewing the antenna module 200. Each of the third feeding portion and the fourth feeding portion may be positioned within an area of the second patch radiator and within an area of the second patch portion 452 of the third radiator array 330, when viewing the antenna module 200. Each of the fifth feeding portion and the sixth feeding portion may be positioned within an area of the third patch radiator and outside the area of the first patch portion 451 of the third radiator array 330, when viewing the antenna module 200. Each of the seventh feeding portion and the eighth feeding portion may be positioned within an area of the fourth patch radiator and outside the area of the second patch portion 452 of the third radiator array 330, when viewing the antenna module 200. The first patch portion 451 and the second patch portion 452 may be symmetrical with respect to an axis related to the gap 465. When viewing the antenna module 200, a position of the first feeding portion may be symmetrical to a position of the fourth feeding portion with respect to the axis. When viewing the antenna module 200, a position of the second feeding portion may be symmetrical to a position of the third feeding portion with respect to the axis. When viewing the antenna module 200, a position of the fifth feeding portion may be symmetrical to a position of the eighth feeding portion with respect to the axis. When viewing the antenna module 200, a position of the sixth feeding portion may be symmetrical to a position of the seventh feeding portion with respect to the axis.

For example, the antenna module 200 may further include radio frequency (RF) processing circuitry and power management circuitry. The RF processing circuitry and the power management circuitry may be coupled to the side of the circuitry board 305. The plurality of radiators may include a first set of layers comprising a feeding structure for electrically connecting the RF processing circuitry to each patch radiator of the first radiator array 310, each patch radiator of the second radiator array 320, and each patch radiator of the third radiator array 330, and a second set of layers comprising each patch radiator of the first radiator array 310, each patch radiator of the second radiator array 320, and each patch radiator of the third radiator array 330.

For example, the RF processing circuitry may include first RF processing circuitry for processing signals having a first polarization through up-conversion or down-conversion, second RF processing circuitry for processing signals having a second polarization through up-conversion or down-conversion, and third RF processing circuitry for amplifying signals of the third frequency band without frequency conversion.

For example, the first radiator array 310 may further include patch radiators having the first size and disposed on a fourth layer between the first layer and the second layer. The second radiator array 320 may further include patch radiators having the second size and disposed on a fifth layer above the second layer with respect to the side.

For example, each antenna element of the first radiator array 310 may comprise a rectangular patch disposed on each of the first layer and the fourth layer. Each antenna element of the second radiator array 320 may comprise a rectangular patch disposed on each of the second layer and the fifth layer. The third radiator array 330 may comprise a first antenna element and a second antenna element disposed on the third layer. The first antenna element may be disposed between two antenna elements of the first radiator array 310. The second antenna element may be disposed between another two antenna elements of the first radiator array 310.

For example, the first frequency band may belong to frequency range (FR) 2 having a frequency equal to or higher than 24.25 gigahertz (GHz). The second frequency band may belong to the FR 2. The third frequency band may belong to FR 3 having a frequency equal to or higher than 7.125 GHz and lower than 24.25 GHz. A distance between two adjacent patch radiators of the third radiator array 330 may be longer than a distance between the two adjacent patch radiators of the first radiator array 310. The distance between the two adjacent patch radiators of the first radiator array 310 may be longer than a distance between two adjacent patch radiators of the second radiator array 320.

For example, the wireless communication circuitry may comprise first transmit/receive processing circuitry for processing signals having a first polarization to be transmitted on the first frequency band or the second frequency band, second transmit/receive processing circuitry for processing signals having a second polarization to be transmitted on the first frequency band or the second frequency band, and a local oscillator (LO) for providing an oscillation frequency. The first transmit/receive processing circuitry may be configured to, based on the oscillation frequency, output signals having the first polarization on which intermediate frequency processing is performed for the first frequency band or the second frequency band, or output signals of the third frequency band. The second transmit/receive processing circuitry may be configured to, based on the oscillation frequency, output signals having the second polarization on which intermediate frequency processing is performed for the first frequency band or the second frequency band, or output signals of the third frequency band.

For example, the signals of the third frequency band output from the first transmission/reception processing circuitry may be provided to a first patch radiator of the third radiator array 330 through the antenna module 200.

For example, the signals of the third frequency band output from the second transmission/reception processing circuitry may be provided to a second patch radiator of the third radiator array through the antenna module.

For example, the wireless communication circuitry may include first wireless communication circuitry for processing signals of the first frequency band or the second frequency band and second wireless communication circuitry for processing signals of the third frequency band. The first wireless communication circuitry may include first transmit/receive processing circuitry for processing signals having a first polarization to be transmitted on the first frequency band or the second frequency band, second transmit/receive processing circuitry for processing signals having a second polarization to be transmitted on the first frequency band or the second frequency band, and a first local oscillator (LO) for providing a first oscillation frequency for intermediate frequency processing. The second wireless communication circuitry may include third transmit/receive processing circuitry for processing first signals to be transmitted on the third frequency band, fourth transmit/receive processing circuitry for processing second signals to be transmitted on the third frequency band, and a second LO for providing a second oscillation frequency for frequency conversion related to the third frequency band.

For example, the signals having the first polarization output from the first transmission/reception processing circuitry may be provided to each patch radiator of the first radiator array 310 or each patch radiator of the second radiator array 320 after up-conversion in the antenna module 200. The signals having the second polarization output from the second transmission/reception processing circuitry may be provided to each patch radiator of the first radiator array 310 or each patch radiator of the second radiator array 320 after up-conversion in the antenna module 200. The signals of the third frequency band output from the third transmission/reception processing circuitry may be provided to a first patch radiator of the third radiator array 330 through the antenna module 200. The signals of the third frequency band output from the fourth transmission/reception processing circuitry may be provided to a second patch radiator of the third radiator array 330 through the antenna module 200.

In various example embodiments of the present disclosure, an antenna module 200 is provided. The antenna module 200 may comprise a circuit board 305 on which a first radiator array 310 for a first frequency band, a second radiator array 320 for a second frequency band higher than the first frequency band, and a third radiator array 330 for a third frequency band lower than the first frequency band are disposed, and radio frequency (RF) processing circuitry coupled to a side of the circuitry board 305. The first radiator array 310 may include patch radiators having a first size, disposed on a first layer among a plurality of layers of the circuit board 305. The second radiator array 320 may include patch radiators having a second size smaller than the first size, disposed on a second layer above the first layer with respect to the side of the circuit board 305 among the plurality of layers of the circuit board 305. The third radiator array 330 may include patch radiators having a third size larger than the first size, disposed on a third layer below the first layer with respect to the side of the circuit board 305 among the plurality of layers of the circuit board 305. The patch radiators disposed on the second layer may be disposed to overlap the patch radiators disposed on the first layer, respectively. The patch radiators disposed on the third layer may include a patch radiator having a first patch portion 451 partially overlapping with one of two adjacent patch radiators among the patch radiators disposed on the first layer and a second patch portion 452 partially overlapping with another of the two adjacent patch radiators. A gap 465 formed between the first patch portion 451 and the second patch portion 452 may be disposed on an area between the two adjacent patch radiators.

For example, the first patch portion 451 may have a shape in which a notch is formed on a second side opposite to a first side adjacent to the gap 465 in a direction toward the gap 465. The second patch portion 452 may have a shape symmetrical to the first patch portion 451 with respect to an axis related to the gap 465.

For example, the antenna module 200 may comprise a first set of conductive vias for connecting a ground layer of the circuit board 305 and the first patch portion 451, a second set of conductive vias for connecting the ground layer of the circuit board 305 and the second patch portion 452, and a feeding portion for providing signals of the third frequency band to the first patch portion 451.

For example, the two adjacent patch radiators in the first radiator array 310 may include a first patch radiator and a second patch radiator. The patch radiators disposed on the second layer in the second radiator array 320 may include a third patch radiator and a fourth patch radiator. The third patch radiator may be disposed to be fully overlapped with the first patch radiator when viewing the antenna module 200. The fourth patch radiator may be disposed to be fully overlapped with the second patch radiator when viewing the antenna module 200. The circuit board 305 may include a first feeding portion for providing signals having a first polarization to the first patch radiator of the first layer, a second feeding portion for providing signals having a second polarization to the first patch radiator of the first layer, a third feeding portion for providing signals having the first polarization to the second patch radiator of the first layer, a fourth feeding portion for providing signals having the second polarization to the second patch radiator of the first layer, a fifth feeding portion for providing signals having the first polarization to the third patch radiator of the second layer, a sixth feeding portion for providing signals having the second polarization to the third patch radiator of the second layer, a seventh feeding portion for providing signals having the first polarization to the fourth patch radiator of the second layer, and an eighth feeding portion for providing signals having the second polarization to the fourth patch radiator of the second layer.

For example, each of the first feeding portion and the second feeding portion may be positioned within an area of the first patch radiator and outside an area of the first patch portion 451 of the third radiator array 330, when viewing the antenna module 200. Each of the third feeding portion and the fourth feeding portion may be positioned within an area of the second patch radiator and outside an area of the second patch portion 452 of the third radiator array 330, when viewing the antenna module 200. Each of the fifth feeding portion and the sixth feeding portion may be positioned within an area of the first patch radiator and within the area of the first patch portion 451 of the third radiator array 330, when viewing the antenna module 200. Each of the seventh feeding portion and the eighth feeding portion may be positioned within an area of the second patch radiator and within the area of the second patch portion 452 of the third radiator array 330, when viewing the antenna module 200. The first patch portion 451 and the second patch portion 452 may be symmetrical with respect to an axis related to the gap 465. When viewing the antenna module 200, a position of the first feeding portion may be symmetrical to a position of the fourth feeding portion with respect to the axis. When viewing the antenna module 200, a position of the second feeding portion may be symmetrical to a position of the third feeding portion with respect to the axis. When viewing the antenna module 200, a position of the fifth feeding portion may be symmetrical to a position of the eighth feeding portion with respect to the axis. When viewing the antenna module 200, a position of the sixth feeding portion may be symmetrical to a position of the seventh feeding portion with respect to the axis.

For various embodiments, at least one of components described in one or more of the preceding drawings may be configured to perform one or more operations, techniques, processes and/or methods as described in the present disclosure. For example, a processor (e.g., a baseband processor) described in the present disclosure associated with one or more of the preceding drawings may be configured to operate according to one or more examples described in the present disclosure. For another example, circuitry related to user equipment (UE), a base station, a network element, and the like, as described above associated with one or more of the previous drawings, may be configured to operate according to one or more examples described herein.

Any of the embodiments described above may be combined with any other embodiment (or a combination of embodiments) unless otherwise explicitly stated. The above-described description of one or more implementations provides examples and descriptions, but is not intended to limit or thoroughly limit the scope of in the disclosure to the precise form disclosed. It may be modified in light of the above teachings or may be obtained from various embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
at least one processor comprising processing circuitry;
wireless communication circuitry coupled to at least one processor; and
an antenna module coupled to the wireless communication circuitry,
wherein the antenna module includes: a circuit board on which a first radiator array for a first frequency band, a second radiator array for a second frequency band higher than the first frequency band, and a third radiator array for a third frequency band lower than the first frequency band are disposed,
wherein the first radiator array includes patch radiators having a first size, disposed on a first layer among a plurality of layers of the circuit board,
wherein the second radiator array includes patch radiators having a second size smaller than the first size, disposed on a second layer above the first layer with respect to a side of the circuit board among the plurality of layers of the circuit board,
wherein the third radiator array includes patch radiators having a third size larger than the first size, disposed on a third layer below the first layer with respect to the side of the circuit board among the plurality of layers of the circuit board,
wherein the patch radiators disposed on the second layer of the circuit board are disposed to overlap the patch radiators disposed on the first layer of the circuit board, respectively,
wherein the patch radiators disposed on the third layer of the circuit board include a patch radiator having a first patch portion partially overlapping one of two adjacent patch radiators among the patch radiators disposed on the first layer of the circuit board and a second patch portion partially overlapping another of the two adjacent patch radiators, and
wherein a gap between the first patch portion and the second patch portion is disposed on an area between the two adjacent patch radiators.

2. The electronic device of claim 1,
wherein the first patch portion has a shape including a notch formed on a second side opposite to a first side adjacent to the gap in a direction toward the gap, and
wherein the second patch portion has a shape symmetrical to the first patch portion with respect to an axis related to the gap.

3. The electronic device of claim 2, further comprising:
a first set of conductive vias for connecting a ground layer of the circuit board and the first patch portion;
a second set of conductive vias for connecting the ground layer of the circuit board and the second patch portion; and
a feeding portion configured to provide signals of the third frequency band to the first patch portion.

4. The electronic device of claim 1,
wherein the two adjacent patch radiators in the first radiator array include a first patch radiator and a second patch radiator,
wherein the patch radiators disposed on the second layer of the circuit board in the second radiator array include a third patch radiator and a fourth patch radiator,
wherein the third patch radiator is disposed to fully overlap with the first patch radiator when viewing the antenna module from above, and
wherein the fourth patch radiator is disposed to fully overlap with the second patch radiator when viewing the antenna module from above, and
wherein the circuit board includes:
a first feeding portion configured to provide signals having a first polarization to the first patch radiator of the first layer of the circuit board,
a second feeding portion configured to provide signals having a second polarization to the first patch radiator of the first layer of the circuit board,
a third feeding portion configured to provide signals having the first polarization to the second patch radiator of the first layer of the circuit board,
a fourth feeding portion configured to provide signals having the second polarization to the second patch radiator of the first layer of the circuit board,
a fifth feeding portion configured to provide signals having the first polarization to the third patch radiator of the second layer of the circuit board,
a sixth feeding portion configured to provide signals having the second polarization to the third patch radiator of the second layer of the circuit board,
a seventh feeding portion configured to provide signals having the first polarization to the fourth patch radiator of the second layer of the circuit board, and
an eighth feeding portion configured to provide signals having the second polarization to the fourth patch radiator of the second layer of the circuit board.

5. The electronic device of claim 4,
wherein each of the first feeding portion and the second feeding portion is positioned within an area of the first patch radiator and outside an area of the first patch portion of the third radiator array, when viewing the antenna module from above,
wherein each of the third feeding portion and the fourth feeding portion is positioned within an area of the second patch radiator and outside an area of the second patch portion of the third radiator array, when viewing the antenna module,
wherein each of the fifth feeding portion and the sixth feeding portion is positioned within an area of the third patch radiator and within the area of the first patch portion of the third radiator array, when viewing the antenna module,
wherein each of the seventh feeding portion and the eighth feeding portion is positioned within an area of the fourth patch radiator and within the area of the second patch portion of the third radiator array, when viewing the antenna module,
wherein the first patch portion and the second patch portion are symmetrical with respect to an axis related to the gap,
wherein, when viewing the antenna module, a position of the first feeding portion is symmetrical to a position of the fourth feeding portion with respect to the axis,
wherein, when viewing the antenna module, a position of the second feeding portion is symmetrical to a position of the third feeding portion with respect to the axis,
wherein, when viewing the antenna module, a position of the fifth feeding portion is symmetrical to a position of the eighth feeding portion with respect to the axis, and
wherein, when viewing the antenna module, a position of the sixth feeding portion is symmetrical to a position of the seventh feeding portion with respect to the axis.

6. The electronic device of claim 4,
wherein each of the first feeding portion and the second feeding portion is positioned within an area of the first patch radiator and within an area of the first patch portion of the third radiator array, when viewing the antenna module from above,
wherein each of the third feeding portion and the fourth feeding portion is positioned within an area of the second patch radiator and within an area of the second patch portion of the third radiator array, when viewing the antenna module,
wherein each of the fifth feeding portion and the sixth feeding portion is positioned within an area of the third patch radiator and outside the area of the first patch portion of the third radiator array, when viewing the antenna module,
wherein each of the seventh feeding portion and the eighth feeding portion is positioned within an area of the fourth patch radiator and outside the area of the second patch portion of the third radiator array, when viewing the antenna module,
wherein the first patch portion and the second patch portion are symmetrical with respect to an axis related to the gap,
wherein, when viewing the antenna module, a position of the first feeding portion is symmetrical to a position of the fourth feeding portion with respect to the axis,
wherein, when viewing the antenna module, a position of the second feeding portion is symmetrical to a position of the third feeding portion with respect to the axis,
wherein, when viewing the antenna module, a position of the fifth feeding portion is symmetrical to a position of the eighth feeding portion with respect to the axis, and
wherein, when viewing the antenna module, a position of the sixth feeding portion is symmetrical to a position of the seventh feeding portion with respect to the axis.

7. The electronic device of claim 1,
wherein the antenna module further includes radio frequency (RF) processing circuitry and power management circuitry,
wherein the RF processing circuitry and the power management circuitry are coupled to the side of the circuitry board,
wherein the plurality of radiators includes:
a first set of layers comprising a feeding structure for electrically connecting the RF processing circuitry to each patch radiator of the first radiator array, each patch radiator of the second radiator array, and each patch radiator of the third radiator array, and
a second set of layers comprising each patch radiator of the first radiator array, each patch radiator of the second radiator array, and each patch radiator of the third radiator array.

8. The electronic device of claim 7,
wherein the RF processing circuitry includes first RF processing circuitry configured to process signals having a first polarization through up-conversion or down-conversion, second RF processing circuitry configured to process signals having a second polarization through up-conversion or down-conversion, and third RF processing circuitry configured to amplify signals of the third frequency band without frequency conversion.

9. The electronic device of claim 1,
wherein the first radiator array further includes patch radiators having the first size and disposed on a fourth layer of the circuit board between the first layer of the circuit board and the second layer of the circuit board, and
wherein the second radiator array further includes patch radiators having the second size and disposed on a fifth layer of the circuit board above the second layer of the circuit board with respect to the side.

10. The electronic device of claim 9,
wherein each antenna element of the first radiator array comprises a rectangular patch disposed on each of the first layer of the circuit board and the fourth layer of the circuit board,
wherein each antenna element of the second radiator array comprises a rectangular patch disposed on each of the second layer of the circuit board and the fifth layer of the circuit board,
wherein the third radiator array comprises a first antenna element and a second antenna element disposed on the third layer of the circuit board,
wherein the first antenna element is disposed between two antenna elements of the first radiator array, and
wherein the second antenna element is disposed between another two antenna elements of the first radiator array.

11. The electronic device of claim 1,
wherein the first frequency band belongs to frequency range (FR) 2 having a frequency equal to or higher than 24.25 gigahertz (GHZ),
wherein the second frequency band belongs to the FR 2,
wherein the third frequency band belongs to FR 3 having a frequency equal to or higher than 7.125 GHz and lower than 24.25 GHz,
wherein a distance between two adjacent patch radiators of the third radiator array is greater than a distance between the two adjacent patch radiators of the first radiator array, and
wherein the distance between the two adjacent patch radiators of the first radiator array is greater than a distance between two adjacent patch radiators of the second radiator array.

12. The electronic device of claim 1,
wherein the wireless communication circuitry comprises:
first transmit/receive processing circuitry configured to process signals having a first polarization to be transmitted on the first frequency band or the second frequency band;
second transmit/receive processing circuitry configured to process signals having a second polarization to be transmitted on the first frequency band or the second frequency band; and
a local oscillator (LO) configured to provide an oscillation frequency,
wherein the first transmit/receive processing circuitry is configured to, based on the oscillation frequency, output signals having the first polarization on which intermediate frequency processing is performed for the first frequency band or the second frequency band, or output signals of the third frequency band, and
wherein the second transmit/receive processing circuitry is configured to, based on the oscillation frequency, output signals having the second polarization on which intermediate frequency processing is performed for the first frequency band or the second frequency band, or output signals of the third frequency band.

13. The electronic device of claim 12,
wherein the signals of the third frequency band output from the first transmission/reception processing circuitry are provided to a first patch radiator of the third radiator array through the antenna module, and
wherein the signals of the third frequency band output from the second transmission/reception processing circuitry are provided to a second patch radiator of the third radiator array through the antenna module.

14. The electronic device of claim 1,
wherein the wireless communication circuitry includes first wireless communication circuitry configured to process signals of the first frequency band or the second frequency band and second wireless communication circuitry configured to process signals of the third frequency band,
wherein the first wireless communication circuitry includes:
first transmit/receive processing circuitry configured to process signals having a first polarization to be transmitted on the first frequency band or the second frequency band,
second transmit/receive processing circuitry configured to process signals having a second polarization to be transmitted on the first frequency band or the second frequency band, and
a first local oscillator (LO) configured to provide a first oscillation frequency for intermediate frequency processing,
wherein the second wireless communication circuitry includes:
third transmit/receive processing circuitry configured to process first signals to be transmitted on the third frequency band,
fourth transmit/receive processing circuitry configured to process second signals to be transmitted on the third frequency band, and
a second LO configured to provide a second oscillation frequency for frequency conversion related to the third frequency band.

15. The electronic device of claim 14,
wherein the signals having the first polarization output from the first transmission/reception processing circuitry are provided to each patch radiator of the first radiator array or each patch radiator of the second radiator array after up-conversion in the antenna module,
wherein the signals having the second polarization output from the second transmission/reception processing circuitry are provided to each patch radiator of the first radiator array or each patch radiator of the second radiator array after up-conversion in the antenna module,
wherein the signals of the third frequency band output from the third transmission/reception processing circuitry are provided to a first patch radiator of the third radiator array through the antenna module, and
wherein the signals of the third frequency band output from the fourth transmission/reception processing circuitry are provided to a second patch radiator of the third radiator array through the antenna module.

16. An antenna module comprising:
a circuit board on which a first radiator array for a first frequency band, a second radiator array for a second frequency band higher than the first frequency band, and a third radiator array for a third frequency band lower than the first frequency band are disposed; and
radio frequency (RF) processing circuitry coupled to a side of the circuitry board,
wherein the first radiator array includes patch radiators having a first size, disposed on a first layer among a plurality of layers of the circuit board,
wherein the second radiator array includes patch radiators having a second size smaller than the first size, disposed on a second layer above the first layer with respect to the side of the circuit board among the plurality of layers of the circuit board,
wherein the third radiator array includes patch radiators having a third size larger than the first size, disposed on a third layer below the first layer with respect to the side of the circuit board among the plurality of layers of the circuit board,
wherein the patch radiators disposed on the second layer are disposed to overlap the patch radiators disposed on the first layer, respectively,
wherein the patch radiators disposed on the third layer include a patch radiator having a first patch portion partially overlapping one of two adjacent patch radiators among the patch radiators disposed on the first layer and a second patch portion partially overlapping another of the two adjacent patch radiators, and
wherein a gap formed between the first patch portion and the second patch portion is disposed on an area between the two adjacent patch radiators.

17. The antenna module of claim 16,
wherein the first patch portion has a shape including a notch formed on a second side opposite to a first side adjacent to the gap in a direction toward the gap, and
wherein the second patch portion has a shape symmetrical to the first patch portion with respect to an axis related to the gap.

18. The antenna module of claim 17, further comprising;
a first set of conductive vias connecting a ground layer of the circuit board and the first patch portion;
a second set of conductive vias connecting the ground layer of the circuit board and the second patch portion; and
a feeding portion configured to provide signals of the third frequency band to the first patch portion.

19. The antenna module of claim 16,
wherein the two adjacent patch radiators in the first radiator array include a first patch radiator and a second patch radiator,
wherein the patch radiators disposed on the second layer in the second radiator array include a third patch radiator and a fourth patch radiator,
wherein the third patch radiator is disposed to fully overlap the first patch radiator when viewing the antenna module from above, and
wherein the fourth patch radiator is disposed to fully overlap the second patch radiator when viewing the antenna module, and
wherein the circuit board includes:
a first feeding portion configured to provide signals having a first polarization to the first patch radiator of the first layer,
a second feeding portion configured to provide signals having a second polarization to the first patch radiator of the first layer,
a third feeding portion configured to provide signals having the first polarization to the second patch radiator of the first layer,
a fourth feeding portion configured to provide signals having the second polarization to the second patch radiator of the first layer,
a fifth feeding portion configured to provide signals having the first polarization to the third patch radiator of the second layer,
a sixth feeding portion configured to provide signals having the second polarization to the third patch radiator of the second layer,
a seventh feeding portion configured to provide signals having the first polarization to the fourth patch radiator of the second layer, and
an eighth feeding portion configured to provide signals having the second polarization to the fourth patch radiator of the second layer.

20. The antenna module of claim 19,
wherein each of the first feeding portion and the second feeding portion is positioned within an area of the first patch radiator and outside an area of the first patch portion of the third radiator array, when viewing the antenna module from above,
wherein each of the third feeding portion and the fourth feeding portion is positioned within an area of the second patch radiator and outside an area of the second patch portion of the third radiator array, when viewing the antenna module,
wherein each of the fifth feeding portion and the sixth feeding portion is positioned within an area of the first patch radiator and within the area of the first patch portion of the third radiator array, when viewing the antenna module,
wherein each of the seventh feeding portion and the eighth feeding portion is positioned within an area of the second patch radiator and within the area of the second patch portion of the third radiator array, when viewing the antenna module,
wherein the first patch portion and the second patch portion are symmetrical with respect to an axis related to the gap,
wherein, when viewing the antenna module, a position of the first feeding portion is symmetrical to a position of the fourth feeding portion with respect to the axis,
wherein, when viewing the antenna module, a position of the second feeding portion is symmetrical to a position of the third feeding portion with respect to the axis,
wherein, when viewing the antenna module, a position of the fifth feeding portion is symmetrical to a position of the eighth feeding portion with respect to the axis, and
wherein, when viewing the antenna module, a position of the sixth feeding portion is symmetrical to a position of the seventh feeding portion with respect to the axis.
